(19) United States
(12) Patent Application Publication
(10) Pub. No.: US 2025/0074782 A1
(43) Pub. Date: Mar. 6, 2025

(54) METHOD OF SELECTIVE LITHIUM RECOVERY AS Li2CO3 FROM LITHIUM-ION BATTERY WASTE USING A REDUCING AGENT

(71) Applicants: Wook Jin CHUNG, Seoul (KR); SEM Inc., Gyeonggi-do (KR)

(72) Inventors: Wook Jin CHUNG, Seoul (KR); Nisola GRACE, Gyeonggi-do (KR); Gebremedhn Tekeste GEBREMICHAEL, Gyeonggi-do (KR); Hiluf Tekle FISSAHA, Gyeonggi-do (KR); John Edward SIO, Gyeonggi-do (KR)

(21) Appl. No.: 18/820,511

(22) Filed: Aug. 30, 2024

(30) Foreign Application Priority Data
Aug. 30, 2023 (KR) 10-2023-0114152

(51) Int. Cl. C01D 15/08; H01M 10/54

(52) U.S. Cl. CPC C01D 15/08; H01M 10/54; C01P 2002/72; C01P 2006/80

(57) ABSTRACT

The present disclosure may provide a method of producing Li₂CO₃ from heat-treated LIB waste cathode materials, which includes (a) producing a solid mixture of the LIB cathode materials and a reducing agent, (b) heat treatment of the solid mixture that yields Li₂CO₃ (c) obtaining the Li₂CO₃ by water-leaching the heat-treated LIB waste cathode material, and precipitating it in the presence of a co-solvent. The reducing agent is an ammonium-based compound that primarily generates NH₃ and CO₂ during heat treatment.

### CROSS-REFERENCE TO RELATED APPLICATION

This application claims priority to Korean Patent Application No. 10-2023-0114152, filed on Aug. 30, 2024, which is incorporated herein by reference in its entirety. While this application is based on the Korean patent, it has been revised in terms of content order, with certain items removed and others added, to enhance clarity, accuracy, and consistency with the intended scope and disclosure of the original invention.

### FIELD

The present disclosure relates to a method of producing lithium carbonate (Li₂CO₃) from lithium ions selectively extracted from lithium-ion battery wastes treated with a reducing agent.

### BACKGROUND

Lithium-ion batteries (hereinafter referred to as LIBs) are widely used as secondary batteries in portable electronic devices (e.g., mobile phones, laptops, tablets, etc.) and electric vehicles (EVs) due to their high energy density and excellent charge/discharge performance.

A lithium-ion secondary battery comprises a cathode that accounts for 20-40% of the battery's weight. Lithium cobalt oxide (LiCoO₂), known for its excellent reversibility, low self-discharge rate, high capacity, high energy density, and ease of synthesis, is typically used as a cathode material. Additionally, multi-metal oxide cathode materials with a general structure of LiMeO₂ are employed. Examples of such materials may include, but are not limited to, lithium nickel cobalt manganese oxide (NCM), lithium nickel cobalt aluminum oxide (NCA), lithium manganese oxide (LMO) and other cathode materials with similar battery chemistries.

At present, Korea heavily depends on imports of lithium carbonate, a key raw material for lithium-ion secondary batteries. As demand for Li₂CO₃ increases in the future, the price of Li₂CO₃ is expected to soar. Considering the lack of natural lithium reserves in Korea, it is necessary to recover and reuse lithium from waste cathode material defined as scraps generated during a lithium-ion battery manufacturing process or recovered from defective and/or end-of-life LIBs.

### SUMMARY

The present disclosure relates to a method of producing high-purity Li₂CO₃ by selectively recovering lithium ions from LIB waste cathode material.

The embodiments of the present invention are not limited to those described above; additional elements of the invention that are not explicitly mentioned will be apparent to those skilled in the art from the following description.

The present invention discloses the use of solid agents for lithium recovery capable of supplying reducing gases during thermal decomposition of LIB waste cathode material.

The LIB waste cathode material may include at least one selected from the group consisting of NCM, LCO, NCA, LCO, LMO, and any combination thereof.

The LIB waste cathode material can be a process scrap (PS) from LIB manufacturing process or recovered as black mass (BM) from end-of-life LIBs.

In some embodiments of the current invention, PS typically contains mainly cathode materials whereas BM may additionally contain graphite and silica.

The diameter of the LIB waste cathode materials may be less than 100 μm.

To achieve the objectives, the present invention discloses the use of a reducing agent for the LIB waste cathode material, which is an ammonium-based compound that generates the reducing gases during thermal treatment.

In addition, the present disclosure provides a method of producing Li₂CO₃ from LIB waste material, which includes (a) producing a mixture by mixing LIB waste cathode material and the reducing agent, (b) heat treating the solid mixture and (c) obtaining the Li₂CO₃ solution by water-leaching of the heat-treated LIB waste cathode material, precipitating the Li₂CO₃ using a co-solvent and drying the Li₂CO₃ precipitate as a solid product.

The ammonium-based compound may include, but is not limited to, at least one of the following: ammonium carbonate, ammonium carbamate, ammonium formate, carbamide, ammonium acetate, ammonium oxalate, ammonium citrate dibasic, ammonium citrate tribasic, or any combination thereof.

The ammonium-based compound generates NH₃ as the primary reducing gas during thermal treatment and may further produce, but is not limited to, one or more of the following: H₂, CO, char, or a combination thereof, which can also serve as reducing agents during the thermal treatment. Additionally, CO₂ gas is generated during heat treatment as a by-product of the reaction.

The presence of various reducing gases effectively converts the LIB waste cathode material having LiMeO₂ structure to low-valent metal oxides or zero-valent metal elements and lithium dioxide.

The generated CO₂ gas by-product reacts with lithium dioxide to form Li₂CO₃, a water-soluble compound. This solubility allows Li₂CO₃ to be selectively extracted using water, while the reduced metal oxides, being insoluble, remain in solid form.

The mixture may be obtained by mixing the LIB waste cathode material and the reducing agent at a weight ratio of 1:1 to 1:4 (LIB waste cathode material:reducing agent).

The heat treatment may be performed in the presence of Ar or N₂ inert gas, at 300-700° C. for 5-60 minutes with a heating rate ranging 10-30° C. min⁻¹.

The heat-treated LIB waste cathode material can be mixed with water and agitated at room temperature for 10 mins to several hours, allowing for the extraction of Li₂CO₃ in the aqueous solution.

The co-solvent may be isopropyl alcohol or any compound that is water-miscible but induces Li₂CO₃ to precipitate. The co-solvent can be added to the leaching solution at 25 to 170 (v/v) %.

Before adding the co-solvent, sodium carbonate (Na₂CO₃) can be added to the water leaching solution to ensure that all Li ions are in the form of Li₂CO₃.

The precipitated Li₂CO₃ can be separated from the solution using various solid/liquid separation methods, including but not limited to centrifugation, membrane filtration, or any other appropriate separation technique.

The collected Li₂CO₃ may be dried at a temperature ranging from 60 to 100° C. for 6 to 24 hours.

It should be understood that the effects of the present disclosure are not limited to those explicitly described above and include all effects inferable from the configuration of the invention described in the detailed description or claims of the present disclosure.

### BRIEF DESCRIPTION OF THE DRAWINGS

FIG. 1 is a schematic diagram of a method of producing high-purity Li₂CO₃ by recovering lithium from a cathode material of LIB waste according to one embodiment of the present disclosure.

FIG. 2 shows the XRD spectra of LIB wastes PS and BM according to one embodiment of the present disclosure.

FIG. 3 shows the results of particle size distribution of LIB wastes PS and BM according to one embodiment of the present disclosure.

FIG. 4 shows the results of thermogravimetric analysis for the reducing agents as sources for various types of reducing gases at a ramping rate of 20° C. min⁻¹ under a N₂ atmosphere.

FIG. 5 shows the results of thermogravimetric analysis of a mixture of BM or PS at a mass ratio of 1:2 with the reducing agent (LIB waste cathode material:reducing agent) at the ramping rate of 20° C. min⁻¹ under N₂ atmosphere.

FIG. 6 shows the scanning electron microscope (SEM) images of LIB wastes BM (containing low Li as BM-LLi, moderate Li as BM-MLi) or PS (containing high Li as PS-HLi) before and after the heat treatment, and after water leaching.

FIG. 7 shows the XRD spectra of the heat-treated LIB waste cathode materials before and after heat-treatment using various reducing agents.

FIG. 8 shows the % Li⁺ leaching efficiency and Li⁺ leaching selectivity of heat-treated LIB waste cathode materials using various reducing agents.

FIGS. 9A, 9B, 9C, 9D, 9E, 9F, 9G, and 9H illustrate % Li⁺ leaching efficiency and Li⁺ leaching selectivity from optimization strategies performed by changing the conditions of heat treatment temperature, heat treatment retention time, type of reducing agent, and mixing ratio of LIB waste and the agent.

Particularly FIG. 9A shows the Li⁺ leaching efficiency of BM-MLi added with eight types of reducing agents and heat treated at different temperatures (500 to 650° C.),

FIG. 9B shows the equivalent Li⁺ leaching selectivity of the systems described in FIG. 9A,

FIG. 9C shows Li⁺ leaching efficiency of process scrap PS-HLi heat treated at different temperatures (ranging from 475 to 650° C.) and mass ratio of PS-HLi and reducing agent (1.25 or 1.5:1),

FIG. 9D shows the equivalent Li⁺ leaching selectivity of the systems described in FIG. 9C,

FIG. 9E shows the Li⁺ leaching efficiency and Li⁺ leaching selectivity of BM-MLi heat treated at different reaction times (10-40 mins) using AMC reducing agent,

FIG. 9F shows the results of Li⁺ leaching efficiency and Li⁺ leaching selectivity of BM-MLi at different mass ratios with CAR reducing agent (3:1.25-6 BM:agent),

FIG. 9G shows the Li⁺ leaching efficiency and Li⁺ leaching selectivity of PS-HLi at different mass ratios with AA reducing agent (2:1.9-4.7), and

FIG. 9H shows the Li⁺ leaching efficiency and Li⁺ leaching selectivity of PS-HLi at different mass ratios (2:1.9-3.8) with ACD reducing agent.

FIG. 10 shows XRD spectra after water leaching of heat-treated BM-MLi, BM-LLi, and PS-HLi using different reducing agents described in FIG. 8 (n=3 times washing).

FIG. 11A and 11B shows the precipitation results of Li₂CO₃ using a co-solvent, in which FIG. 11A shows the effect of % IPA addition and precipitation temperature and FIG. 11B shows the effect of Li⁺ concentration in a washing solution on precipitation efficiency.

FIG. 12 shows the results of XRD analysis for Li₂CO₃ obtained according to Example 1.

### DETAILED DESCRIPTION

In the following description, only the parts necessary for understanding the embodiments of the present disclosure are described, and the description of other parts may be omitted if they do not affect the essence of the present disclosure. The terms and words used herein should not be interpreted strictly according to their conventional meanings but rather in a manner that aligns with the technical spirit of the present disclosure. The inventor reserves the right to define terms to best describe the invention. The embodiments and configurations shown in the drawings are exemplary and do not limit the scope of the disclosure, as various equivalents and modifications may be possible.

Hereinafter, the present disclosure will be described in detail.

In the present invention, the LIB waste cathode material may have a general structure of LiMeO₂, where Me refers to, but is not limited to, transition metals such as nickel (Ni), cobalt (Co), manganese (Mn), and aluminum (Al), or any combination thereof. Examples of such materials include LCO (LiCoO₂), NCM (Li(NiₓCo_{y}Mn_{1-x-y})O₂), NCA (Li(NiₓCo_{y}Al_{1-x-y})O₂), LMO (LiMnO₂) or any cathode material with similar structure and battery chemistry.

The LIB waste cathode material can be a process scrap (PS) from LIB manufacturing process or recovered as black mass (BM) from end-of-life LIBs.

The LIB waste cathode material, PS, typically consists primarily of cathode active materials and may optionally contain other elements commonly found in LIB manufacturing.

The LIB waste cathode material, BM, may be produced after the crushing, mechanical shredding and separation of base metals from discharged EOL batteries. The BM may additionally contain graphite (5-30 wt %) and silica along with the cathode materials, and may or may not include binders, polymers from the separator, and electrolytes, consequent the specifics of the LIB waste recycling process.

Both PS or BM may include, but are not limited to, Al as cathode current collector, Cu as anode current collector, Fe, and others. However, their minimal presence or absence is preferable for a more efficient reduction process.

It is preferable that the PS or BM is not subjected to pre-heat treatment above 300° C. prior to thermal reduction, as such treatment has been shown to decrease Li recovery efficiency during the subsequent water leaching step.

The present disclosure provides a reducing agent for lithium recovery, which is an ammonium-based compound that generates NH₃ gas as a reducing agent during heat treatment.

Additionally, the ammonium-based compound may also generate CO₂ gas as a by-product during heat treatment.

The ammonium-based compound may additionally produce at least one reducing agent, either in gas or solid form, selected from, but not limited to, the group consisting of H₂, CO, char, and a combination thereof during heat treatment.

The ammonium-based compound may include, but is not limited to, at least one selected from the group consisting of ammonium carbonate, ammonium carbamate, ammonium formate, carbamide, ammonium acetate, ammonium oxalate, ammonium citrate dibasic, ammonium citrate tribasic, and a combination thereof.

In addition, the present disclosure provides a method of producing Li₂CO₃ from LIB waste material, which includes (a) producing a mixture by mixing LIB waste cathode material and the reducing agent, (b) heat treating the solid mixture and (c) obtaining the Li₂CO₃ solution by water-leaching of the heat-treated LIB waste cathode material, precipitating the Li₂CO₃ using a co-solvent and drying the Li₂CO₃ precipitate as a solid product.

The first step (a) of the method described in the present invention involves mixing the LIB waste PS or BM with one of the solid agents at a known mole or mass ratio of 1:1 to 1:4. When the reducing agent is mixed with the LIB waste within the above range, it is possible to maximize Li leaching efficiency. Mixing can be done manually or mechanically using a ball mill or any type of mixer.

The particle diameter of the LIB waste cathode material, as well as its final mixture with the solid reducing agent, is preferably less than 100 μm. While a wide particle size distribution is acceptable, maintaining a diameter of less than 100 μm facilitates rapid thermochemical reaction kinetics and ensures excellent uniformity in the reduction products.

The second step involves the heat-treatment of the LIB waste cathode materials (b). The mixed solids are transferred to a heat-sink sagger tray and placed in a sealed furnace, such as a tube-type alumina furnace or a roller hearth kiln. The sample depth is preferably between 7 mm and 10 mm to optimize thermal reduction efficiency. Alternatively, the solid mixture can be fed into a rotary kiln.

The furnace is maintained under an anoxic atmosphere by supplying an inert gas, such as Ar or N₂. The supply of inert gas is crucial to maintaining effective contact between the gases generated by the reducing agent and the LIB waste; insufficient supply can reduce thermal reduction efficiency. When supplied at a rate of 0.02 to 0.05 furnace volumes per minute, the thermal reduction efficiency can be enhanced, and the lithium leaching efficiency can be preserved.

Gradual heating is applied at a rate of 10-30° C. min 1 to ensure controlled evolution of reducing gases from the solid agent, thereby enhancing thermal reduction efficiency.

The final thermo-chemical reduction temperature can be in the range of 300-700° C., specifically, from 450 to 650° C., and more specifically, 550° C. for an efficient reduction and for practical operation.

The thermal treatment time can last from 5 mins-60 mins, preferably below 60 mins for practical operation.

The reducing gases generated from the reducing agent may reduce the transition metal oxides in the LIB waste cathode materials LiMeO₂ into a low-valent Me₃O₄, MeO or zero-valent Me and Li₂O, with Li₂CO₃ formed in-situ during heat treatment from the reaction of the Li₂O and the generated CO₂, at a specific mass ratio of the LIB waste cathode material and reducing agent, heat treatment temperature, and reaction time under an inert atmosphere.

Following the thermal treatment of LIB wastes with various solid agents, the final step (c) discloses the production of Li₂CO₃ from the heat-treated LIB waste cathode material.

The final step (c) includes: (c-1) water-leaching the heat-treated LIB waste cathode material using water; (c-2) adding sodium carbonate to the leaching solution obtained in step (c-1); (c-3) precipitating Li₂CO₃ by adding a co-solvent to the leaching solution obtained in step (c-2); (c-4) separating and recovering the precipitated Li₂CO₃ from step (c-3); and (c-5) drying the recovered Li₂CO₃ from step (c-4).

The water leaching process (step c-1) involves adding a measured volume of water, adjustable based on the expected lithium content in the heat-treated waste. To maximize lithium recovery, washing can be repeated 2-5 times, preferably 2-3 times.

Water leaching (step c-1) can be carried out at 200 to 1000 rpm, specifically, 400 rpm, for a fast Li leaching speed.

Water leaching time (step c-1) may be within 10 minutes to 6 hours, specifically, within 30 minutes, depending on the lithium leaching kinetics, and on the type of thermal treatment and LIB waste cathode material.

In one embodiment, water leaching (step c-1) may be conducted at room temperature or lower, such as in an environment cooler than room temperature, to account for the inverse solubility of Li₂CO₃ in water.

In one embodiment, the addition of Na₂CO₃ (step c-2) in the water leaching solution of Li₂CO₃ is essential to maximize the precipitation of lithium as Li₂CO₃, to prevent the formation of other lithium salt precipitates by inhibiting Li⁺ interaction with other anions present in the solution. Omitting Na₂CO₃ can lead to lower precipitation efficiencies, ranging from 44% to 85%. Na₂CO₃ may be added as a saturated solution (220 g/L), with the volume adjusted between 2% and 5% v/v, depending on the Li⁺ concentration.

The co-solvent could be any water-miscible solvent having a lower dielectric constant (ε=17.9) than water and may be, for example, isopropyl alcohol (step c-3). The co-solvent can be added to the Li₂CO₃ leaching solution at 25 to 150 (v/v) %, preferably between 100% and 150% v/v, to initiate Li₂CO₃ precipitation. In addition, the precipitation may be performed at room temperature or heated at 60° C., thereby increasing the precipitation efficiency of the Li₂CO₃.

After Li₂CO₃ precipitation, centrifugation or membrane filtration with a membrane pore size of less than 0.22 μm can be employed to recover Li₂CO₃ as precipitate (step c-4). A press may be used to dewater the Li₂CO₃ precipitates, which are then washed with an IPA/water solution to minimize the re-dissolution of Li₂CO₃ in water while effectively removing Na⁺ ions from Na₂CO₃. The precipitate can be washed 2 to 6 times, with fewer than 5 washes typically sufficient to remove Na⁺ and achieve a Li₂CO₃ purity of 90% to over 99.5%.

The recovered Li₂CO₃ may be vacuum-dried at a temperature ranging from 60 to 100° C., preferably, 80° C. for 6 to 24 hours, specifically, 12 hours to completely remove water and the co-solvent (step c-5).

### EXAMPLES

The composition of LIB waste cathode materials used in certain embodiments of the present invention are listed in Table 1. The LIB waste BM-LLi is a black mass containing <4 wt % Li whereas BM-MLi contains 5-6 wt % Li. Meanwhile, LIB waste PS-HLi contains >6 wt % Li. The particle distributions of the LIB waste for BM-LLi,

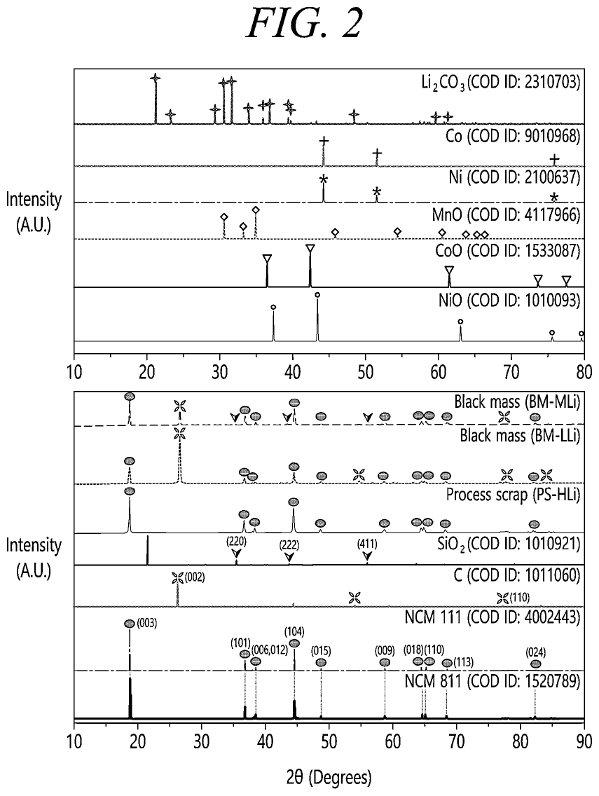

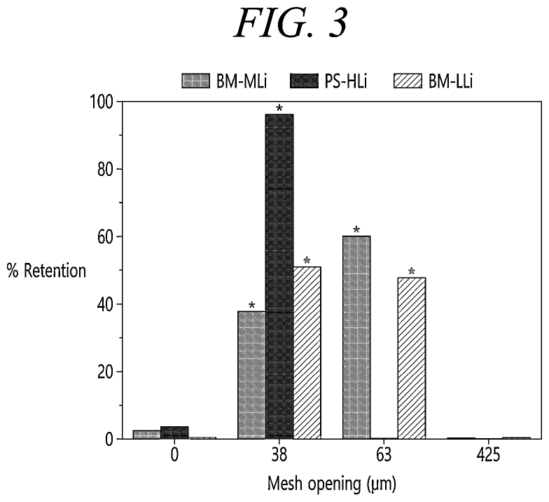

BM-MLi, and PS-HLi are shown in FIG. 3. It was confirmed that the PS-HLi contained only an active material of NCM whereas graphite and silica were additionally present in BM-LLi and BM-MLi (see FIG. 2). Other relevant properties of the LIB waste cathode materials such as density values and moisture content are also listed in Table 1.

TABLE 1
LIB waste cathode materials BM and
PS composition and properties.

| | Black mass | Black mass | Process scrap |
|---|---|---|---|
| Component | (BM-MLi) | (BM-LLi) | (PS-HLi) |
| Li | 5.1 ± 0.07 | 3.87 ± 0.06 | 6.86 ± 0.143 |
| F | 0.68 ± 0 | 0 | 0 |
| Na | 0.67 ± 0.061 | 0.59 ± 0.028 | 0.61 ± 0.035 |
| Al | 2.31 ± 0.22 | 0.78 ± 0.05 | 0.63 ± 0.021 |
| Si | 0.13 ± 0.026 | 0.03 ± 0.014 | 0.04 ± 0.007 |
| Cl | 0.04 | — | 0.013 ± 0 |
| P | 0.37 ± 0.004 | 0.21 ± 0.002 | 0.01 ± 0.003 |
| K | 0.012 ± 0.015 | 0.10 ± 0.006 | 0.11 ± 0.006 |
| Ca | 0.03 ± 0.004 | 0.03 ± 0.001 | 0.02 ± 0.016 |
| Mn | 13.08 ± 0.07 | 6.45 ± 0.22 | 3.84 ± 0.072 |
| Fe | 0.05 ± 0.01 | 0.54 ± 0.04 | 0 |
| Co | 13.84 ± 0.14 | 5.05 ± 0.15 | 2.94 ± 0.016 |
| Ni | 13.54 ± 0.22 | 15.05 ± 0.35 | 52.39 ± 0.750 |
| Cu | 0.68 ± 0.03 | 0.71 ± 0.03 | 0 |
| C | 15.14 ± 0.77 | 43.2 ± 0.74 | 0.33 ± 0.010 |
| H | 0.90 ± 0.07 | 0.62 ± 0.10 | 0.08 ± 0.089 |
| O | 17.93 ± 1.42 | 10.14 ± 0.13 | 22.95 ± 0.419 |
| N | 0 | 0 ± 0 | 0 |
| S | 0.30 ± 0.11 | 0.038 ± 0.13 | 0.21 ± 0.112 |
| Others | 15.21 | 12.59 | 8.917 |
| True density | 1.78 ± 0.21 | 1.59 ± 0.13 | 3.23 ± 0.04 |
| (σ) (g cm⁻³) | | | |
| Tap density | 1.66 ± 0.03 | 1.44 ± 0.014 | 2.80 ± 0.03 |
| (g cm⁻³) | | | |
| Bulk density | 1.46 ± 0.03 | 1.06 ± 0.001 | 2.23 ± 0.001 |
| (g cm⁻³) | | | |
| Moisture | 0.95 ± 0.06 | 1.86 ± 0.08 | 0.45 ± 0.07 |
| content (%) | | | |

### Example 1

### (a) Production of the Mixture of LIB Waste Cathode Material and Reducing Agent

To prepare the solid mixture, 2 g of BM-MLi and 4 g of a reducing agent listed in Table 2 were mixed using the mortar until the mixture became dark grey in color.

TABLE 2
Solid agents as reducing gas carriers

| Compound name | Chemical Formula | Gas usable as reducing agent |
|---|---|---|
| Ammonium | (NH₄)₂CO₃ | NH₃, CO₂, H₂O |
| carbonate (AMC) | | |
| Ammonium | (NH₄)NH₂COO | NH₃, CO₂ |
| carbamate (AMCR) | | |
| Ammonium formate | NH₄HCO₂ | NH₃, CO₂, H₂ |
| (AMF) | | |
| Carbamide (CAR) | (NH₂)₂CO | NH₃, CO₂, H₂O intermediates: |
| | | biuret, isocyanuric acid, |
| | | cyanuric acid, ammelide, |
| | | ammeline |
| Ammonium acetate | NH₄CH₃CO₂ | NH₃, CO₂, CH₄, ketene, |
| (AA) | | acetamide, H₂O, char |
| Ammonium oxalate | (NH₄)₂C₂O₄ | NH₃, H₂O, CO₂, CO |
| (AO) | | |
| Ammonium Citrate | (NH₃)₂•(CH₂)₂(COOH)₃COH | NH₃, CO₂, H₂O, char (C) |
| dibasic (ACD) | | |
| Ammonium citrate | (NH₃)₃•(CH₂)₂(COOH)₃COH | NH₃, CO₂, H₂O, char (C) |
| tribasic (ACT) | | |

### (b) Production of Heat-Treated LIB Waste Cathode Materials

TABLE 3
Heat-treatment results for BM-MLi using various solid reducing agents.

| | black mass (BM-MLi) composition |
|---|---|
| | (wt. %) (xᵢ) |
| Li | 5.1 ± 0.07 |
| Al | 2.31 ± 0.22 |
| Mn | 13.08 ± 0.07 |
| Fe | 0.05 ± 0.01 |
| Co | 13.84 ± 0.14 |
| Ni | 13.54 ± 0.22 |
| Cu | 0.68 ± 0.03 |

| | reducing agent | | | | | | | |
|---|---|---|---|---|---|---|---|---|
| | AMC | AMCR | AMF | CAR | AO | AA | ACD | ACT |
| heat | 550 | 550 | 550 | 550 | 650 | 550 | 650 | 650 |
| treatment | | | | | | | | |
| temperature | | | | | | | | |
| (° C.) | | | | | | | | |
| reducing | 4 | 4 | 4 | 6 | 4 | 4 | 4 | 4 |
| agent | | | | | | | | |
| addition | | | | | | | | |
| mass (g) | | | | | | | | |
| BM-MLi | 2.09 ± 0.01 | 2.03 ± 0.01 | 2.06 ± 0.01 | 3.02 ± 0.01 | 2.02 ± 0.01 | 2.03 ± 0.03 | 2.04 ± 0.01 | 2.05 ± 0 |
| mass before | | | | | | | | |
| heat | | | | | | | | |
| treatment | | | | | | | | |
| (g) (m_{BM}) | | | | | | | | |
| heat- | 1.88 ± 0.01 | 1.77 ± 0.06 | 1.9 ± 0.09 | 2.59 ± 0.16 | 1.73 ± 0.02 | 1.84 ± 0.04 | 2.44 ± 0.01 | 2.51 ± 0.01 |
| treated | | | | | | | | |
| BM-MLi | | | | | | | | |
| mass (g) | | | | | | | | |
| (m_{BMHT}) | | | | | | | | |
| BM-MLi | 89.74 ± 0.04 | 86.83 ± 3.44 | 91.95 ± 4.98 | 85.73 ± 5.47 | 85.59 ± 0.52 | 90.47 ± 2.89 | 119.82 ± 0.28 | 122.72 ± 0.74 |
| recovery | | | | | | | | |
| rate % | | | | | | | | |

| i = Li, Al, | | | | | | | | |
|---|---|---|---|---|---|---|---|---|
| Mn, etc. | | | | | | | | |
| | heat-treated black mass | | | | | | | |
| | composition (wt. %):(xᵢ^{HT}) | | | | | | | |
| Li | 5.66 ± 0.19 | 5.82 ± 0.15 | 6.38 ± 0.07 | 4.78 ± 0.16 | 5.86 ± 0.11 | 5.67 ± 0.12 | 4.06 ± 0.06 | 4.15 ± 0.1 |
| Al | 2.61 ± 0.06 | 2.5 ± 0.01 | 2.76 ± 0.16 | 2.5 ± 0.02 | 3.32 ± 0.02 | 2.65 ± 0.07 | 2.09 ± 0.05 | 2.22 ± 0.03 |
| Mn | 14.23 ± 0.02 | 14.18 ± 0.31 | 14.44 ± 0.05 | 13.1 ± 0.39 | 14.64 ± 0.04 | 13.76 ± 0.21 | 10.06 ± 0.02 | 10.14 ± 0.33 |
| Co | 15.15 ± 0.02 | 15.06 ± 0.38 | 15.35 ± 0.07 | 13.95 ± 0.6 | 15.64 ± 0.09 | 14.48 ± 0.21 | 10.59 ± 0.06 | 10.77 ± 0.33 |
| Ni | 14.48 ± 0.32 | 14.48 ± 0.44 | 14.56 ± 0.01 | 13.7 ± 0.74 | 14.72 ± 0.03 | 14.26 ± 0.2 | 9.89 ± 0.01 | 10.06 ± 0.2 |
| Cu | 0.84 ± 0.04 | 0.79 ± 0.03 | 0.69 ± 0.03 | 0.67 ± 0 | 0.8 ± 0 | 0.69 ± 0 | 0.53 ± 0.02 | 0.53 ± 0.04 |
| | % retention rate_{_{—}}ᵢ | | | | | | | |
| Li | 99.82 ± 4.76 | 100 ± 10.12 | 100 ± 7.42 | 98.23 ± 1.89 | 100.02 ± 1.94 | 96.91 ± 0.97 | 95.87 ± 1.46 | 100.2 ± 2.31 |
| Al | 100 ± 1.63 | 96.71 ± 5.66 | 100 ± 12.41 | 100 ± 1.57 | 100 ± 0.83 | 100 ± 0.41 | 100 ± 2.93 | 100 ± 1.66 |
| Mn | 97.70 ± 0.8 | 96.78 ± 8.67 | 100 ± 5.09 | 97.36 ± 1.41 | 97.62 ± 0.34 | 94.65 ± 1.61 | 92.66 ± 0.31 | 95.55 ± 3.32 |
| Co | 98.25 ± 1.08 | 97.15 ± 9.08 | 100 ± 5.97 | 97.74 ± 1.45 | 97.95 ± 0.65 | 93.53 ± 1.66 | 92.13 ± 0.4 | 95.87 ± 3.13 |
| Ni | 96.01 ± 1.28 | 95.45 ± 9.19 | 99.08 ± 5.25 | 95.66 ± 0.63 | 94.79 ± 0.09 | 89.33 ± 1.59 | 87.92 ± 0.02 | 91.47 ± 1.99 |
| Cu | 100.17 ± 3.85 | 100 ± 10.76 | 93.43 ± 1.45 | 92.34 ± 1.91 | 100 ± 0.47 | 90.58 ± 2.49 | 95.35 ± 4.15 | 97.55 ± 7.49 |

The solid mixture was placed in an alumina boat and then deployed in a tube-type (alumina) furnace with chamber volume of 2.8 L. The furnace was flushed with N₂ gas by supplying it at 100 mL min⁻¹ for approximately 30 mins. The N₂ gas was then reduced to 50 mL min⁻¹ followed by a programmed heating of the furnace from room temperature to 550° C. at 20° C. min⁻¹ ramping and holding time of 20 mins. The furnace is then cooled naturally which generally takes 2-3 h to reach a temperature <100° C. at which the samples are retrieved from the furnace. Results from the thermal reduction of the solid agent AMC for sample BM-MLi are listed in Table 3. In the same manner, other solid agents were used for the heat treatment of BM-MLi and the results are summarized in Table 3.

### (c) Obtaining Li₂CO₃ by Water-Leaching the Heat-Treated LIB Waste

The heat-treated BM-MLi described in examples 1(a)-1(b) was added with water at an estimated S/L ratio to leach out Li⁺ as Li₂CO₃. For example, as a first wash, 0.8 g of AMC-heat treated BM-MLi was added with 20 mL water (S/L=40 mg/mL). The dispersion is shaken for 20 mins at 300 rpm. The solid is then separated from the supernatant via centrifugation (8000 rpm for 15 min). The supernatant is collected as first wash then the solid is added with another 20 ml of water as second wash. The process is repeated until wash 2 supernatant is collected. Finally, the third wash is performed by adding water at a lower volume of 10 mL (S/L ratio=80) and the washing cycle is repeated. The solid residues containing Ni, Mn, and/or Co can be further processed and recovered as individual metals or as NCM(OH)₂ as cathode precursors. The detailed leaching results for heat treated BM-MLi are summarized in Table 4, which showed that leaching Li efficiencies of 70-90% and leaching selectivities >95% are achieved.

The supernatant separated after the first wash of BM-MLi was put in a continuous stirring reactor, and the temperature was equilibrated at 60° C. A saturated Na₂CO₃ solution was added at 3% (v/v) and the solution was vigorously stirred for 30mins at 60° C. After which, isopropyl alcohol (IPA) was added at 150% (v/v) where precipitation starts instantaneously. The dispersion is allowed to equilibrate its temperature with vigorous stirring for another 30 mins. This is followed by another 30 mins of slow stirring to allow the precipitates to nucleate and agglomerate. The dispersion is collected, and the solids are collected via centrifugation or filtration.

TABLE 4
Water leaching results for heat-treated BM-MLi.

| | | Cᵢ (mg/L) | | | | | | |
|---|---|---|---|---|---|---|---|---|
| | m_{BMHT}_{_{—}}ᵢ | V_{L} = 20 mL | mi^{L} | mi^{L} | mi^{L} | mi^{R} | % | |
| | (m_{BMHT} = 0.80 g) | (1^{st} wash) | (1^{st} wash) | (2^{nd}-3^{rd} wash) | total | (mg) | Leaching | αᵢ |
| AMC | | | | | | | | |
| Li | 45.59 ± 0.23 | 1,650.5 ± 27.58 | 33.01 ± 0.55 | 6.44 ± 0.7 | 39.45 ± 0.15 | 6.14 ± 0.08 | 86.53 | 97.63 |
| Al | 21 ± 0.11 | 89.64 ± 17.2 | 1.79 ± 0.34 | 1.93 ± 0.15 | 3.72 ± 0.49 | 17.28 ± 0.6 | 17.73 | 2.37 |
| Mn | 114.71 ± 0.57 | 0 ± 0 | 0 ± 0 | 0 ± 0 | 0 ± 0 | 114.71 ± 0.57 | 0.00 | 0.00 |
| Fe | 0.18 ± 0 | 0 ± 0 | 0 ± 0 | 0 ± 0 | 0 ± 0 | 0.18 ± 0 | 0.00 | 0.00 |
| Co | 122.09 ± 0.61 | 0 ± 0 | 0 ± 0 | 0 ± 0 | 0 ± 0 | 122.09 ± 0.61 | 0.00 | 0.00 |
| Ni | 116.76 ± 0.58 | 0 ± 0 | 0 ± 0 | 0 ± 0 | 0 ± 0 | 116.76 ± 0.58 | 0.00 | 0.00 |
| Cu | 6.78 ± 0.03 | 0 ± 0 | 0 ± 0 | 0 ± 0 | 0 ± 0 | 6.78 ± 0.03 | 0.00 | 0.00 |
| AMCR | | | | | | | | |
| Li | 46.9 ± 0.23 | 1,652 ± 4.24 | 33.04 ± 0.08 | 7.92 ± 0.01 | 40.96 ± 0.09 | 5.94 ± 0.14 | 87.34 | 97.94 |
| Al | 20.14 ± 0.1 | 85.38 ± 22.23 | 1.71 ± 0.44 | 1.64 ± 0.18 | 3.35 ± 0.62 | 16.8 ± 0.52 | 16.62 | 2.06 |
| Mn | 114.18 ± 0.56 | 0 ± 0 | 0 ± 0 | 0 ± 0 | 0 ± 0 | 114.18 ± 0.56 | 0.00 | 0.00 |
| Fe | 0.13 ± 0 | 0 ± 0 | 0 ± 0 | 0 ± 0 | 0 ± 0 | 0.13 ± 0 | 0.00 | 0.00 |
| Co | 121.3 ± 0.6 | 0 ± 0 | 0 ± 0 | 0 ± 0 | 0 ± 0 | 121.3 ± 0.6 | 0.00 | 0.00 |
| Ni | 116.64 ± 0.57 | 0 ± 0 | 0 ± 0 | 0 ± 0 | 0 ± 0 | 116.64 ± 0.57 | 0.00 | 0.00 |
| Cu | 6.35 ± 0.03 | 0 ± 0 | 0 ± 0 | 0 ± 0 | 0 ± 0 | 6.35 ± 0.03 | 0.00 | 0.00 |
| AMF | | | | | | | | |
| AO | | | | | | | | |
| Li | [symbol] ± 0.07 | [symbol] | 29.37 ± 0.41 | 8.97 ± 0.37 | 38.34 ± 0.04 | 8.6 ± 0.03 | [symbol] | 97.02 |
| Al | [symbol] ± 0.04 | 43.78 ± 3.19 | 0.88 ± 0.08 | 3.7 ± 0.58 | 4.57 ± 0.51 | 22.08 ± 0.47 | 17.15 | 2.98 |
| Mn | 117.53 ± 0.18 | 0 ± 0 | 0 ± 0 | 0 ± 0 | 0 ± 0 | 117.53 ± 0.18 | 0.00 | 0.00 |
| Fe | 0.14 ± 0 | 0 ± 0 | 0 ± 0 | 0 ± 0 | 0 ± 0 | 0.14 ± 0 | 0.00 | 0.00 |
| Co | 124.8 ± 0.19 | 0 ± 0 | 0 ± 0 | 0 ± 0 | 0 ± 0 | 124.8 ± 0.19 | 0.00 | 0.00 |
| Ni | 118.21 ± 0.18 | 0 ± 0 | 0 ± 0 | 0 ± 0 | 0 ± 0 | 118.21 ± 0.18 | 0.00 | 0.00 |
| Cu | [symbol] | 0 ± 0 | 0 ± 0 | 0 ± 0 | 0 ± 0 | [symbol] ± 0.01 | 0.00 | 0.00 |
| AA | | | | | | | | |
| Li | 47.06 ± 0.22 | [symbol] ± 44.55 | 27.11 ± 0.89 | [symbol] | [symbol] | 11.72 ± [symbol] | [symbol] | [symbol] |
| Al | [symbol] ± 0.14 | 42.99 ± 1.57 | [symbol] ± 0.08 | 4.13 ± 0.02 | 4.99 ± 0.05 | [symbol] ± 0.1 | [symbol] | 3.51 |
| Mn | 120.35 ± 0.56 | 0 ± 0 | 0 ± 0 | 0 ± 0 | 0 ± 0 | 120.35 ± 0.56 | 0.00 | 0.00 |
| Fe | 0.13 ± 0 | 0 ± 0 | 0 ± 0 | 0 ± 0 | 0 ± 0 | 0.13 ± 0 | 0.00 | 0.00 |
| Co | 127.42 ± 0.59 | 0 ± 0 | 0 ± 0 | 0 ± 0 | 0 ± 0 | 127.42 ± [symbol] | 0.00 | 0.00 |
| Ni | 120.49 ± [symbol] | 0 ± 0 | 0 ± 0 | [symbol] | 0.03 ± 0.04 | [symbol] ± 0.52 | 0.00 | 0.01 |
| Cu | [symbol] | 0 ± 0 | 0 ± 0 | 0 ± 0 | 0 ± 0 | 5.99 ± 0.03 | 0.00 | 0.00 |
| ACD | | | | | | | | |
| Li | 32.73 ± 0.11 | [symbol] ± 13.44 | 17.33 ± 0.27 | 5.49 ± 0.16 | 22.82 ± [symbol] | 9.9 ± 0.22 | [symbol] | 95.02 |
| Al | 16.82 ± 0.06 | 51.24 ± [symbol] | 1.02 ± 0.18 | 3.62 ± 0.52 | 4.64 ± [symbol] | 12.18 ± 0.71 | [symbol] | 4.98 |
| Mn | [symbol] ± 0.27 | 0 ± 0 | 0 ± 0 | 0 ± 0 | 0 ± 0 | 81.15 ± 0.27 | 0.00 | 0.00 |
| Fe | 0.09 ± 0 | 0 ± 0 | 0 ± 0 | 0 ± 0 | 0 ± 0 | 0.09 ± 0 | 0.00 | 0.00 |
| Co | 86.4 ± 0.28 | 0 ± 0 | 0 ± 0 | 0 ± 0 | 0 ± 0 | 85.4 ± 0.28 | 0.00 | 0.00 |
| Ni | 79.76 ± 0.27 | 0 ± 0 | 0 ± 0 | 0 ± 0 | 0 ± 0 | 79.76 ± 0.27 | 0.00 | 0.00 |
| Cu | 4.31 ± 0.01 | 0 ± 0 | 0 ± 0 | 0 ± 0 | 0 ± 0 | 4.31 ± 0.01 | 0.00 | 0.00 |
| ACT | | | | | | | | |
| Li | [symbol] ± 0.16 | [symbol] | 17.7 ± 0.14 | [symbol] ± 0.13 | 24.32 ± 0 | [symbol] ± 0.17 | 72.97 | 95.87 |
| Al | 17.88 ± 0.09 | 57.11 ± 16.01 | 1.14 ± 0.32 | 2.93 ± 0.1 | 4.07 ± 0.42 | [symbol] | 22.77 | [symbol] |
| Mn | [symbol] ± 0.4 | 0 ± 0 | 0 ± 0 | 0 ± 0 | 0 ± 0 | 81.51 ± 0.4 | 0.00 | 0.00 |
| Fe | 0.02 ± 0 | 0 ± 0 | 0 ± 0 | 0 ± 0 | 0 ± 0 | 0.02 ± 0 | 0.00 | 0.00 |
| Co | [symbol] | 0 ± 0 | 0 ± 0 | 0 ± 0 | 0 ± 0 | 88.56 ± 0.43 | 0.00 | 0.00 |
| Ni | [symbol] ± 0.4 | 0 ± 0 | 0 ± 0 | 0 ± 0 | 0 ± 0 | 80.88 ± 0.4 | 0.00 | 0.00 |
| Cu | 4.3 ± 0.02 | 0 ± 0 | 0 ± 0 | 0 ± 0 | 0 ± 0 | 4.3 ± 0.02 | 0.00 | 0.00 |

[symbol]

indicates data missing or illegible when filed

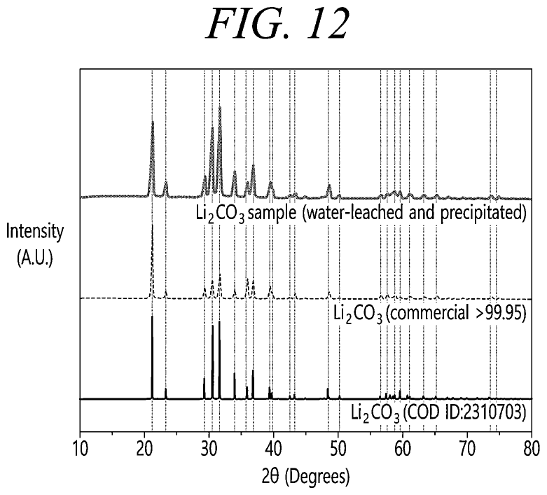

To obtain high purity of Li₂CO₃ powder, the solid was washed several times in IPA/water solution (same composition of precipitation system) at 60° C. For each washing cycle, the solid is vigorously stirred in the washing solution then separated via centrifugation or filtration. After four cycles of washing, the solid is finally collected and vacuum dried overnight at 80° C. The product registered a very clean XRD pattern (see FIG. 12) with precipitation efficiency of 86.78% and 99.86% purity of Li₂CO₃ (Table 5).

TABLE 5
Li₂CO₃ production from heat-treated LIB waste cathode materials.

| | | Li⁺ | | |
|---|---|---|---|---|
| | Agent used for | concentration | | |
| | thermochemical | (First wash) | Precipitation | |
| | reduction | mg L⁻¹ | efficiency % | Purity % |
| BM-MLi | AMC | 1,670 | 86.78 | 99.86 |
| BM-LLi | AMF | 1,337 | 83.87 | 91.97 |
| PS-HLi | AA | 2,372 | 90.82 | 99.62 |

### Example 2A

Li₂CO₃ precipitate was obtained in the same manner as described in Example 1, with the exception that BM-LLi was used in place of BM-MLi, with a composition detailed in Table 1. The results of the thermal reduction of BM-LLi using different reducing agents are presented in Table 6. Detailed leaching results for the heat-treated BM-LLi are shown in Table 7, while the precipitation efficiency and purity of the lithium carbonate are provided in Table 5.

TABLE 6
Heat-treatment results for BM-MLi using various solid reducing agents.

| | black mass (BM-LLi) composition |
|---|---|
| | (wt. %) (xᵢ) |
| Li | 3.87 ± 0.06 |
| Al | 0.78 ± 0.05 |
| Mn | 6.45 ± 0.22 |
| Fe | [symbol] ± 0.04 |
| Co | 5.05 ± 0.15 |
| Ni | 15.05 ± 0.35 |
| Cu | 0.71 ± 0.03 |

| | reducing agent | | | | | | | |
|---|---|---|---|---|---|---|---|---|
| | AMC | AMCR | AMF | CAR | AO | AA | ACD | ACT |
| heat treatment | [symbol] | [symbol] | 4 | [symbol] | 4 | 4 | 4 | 4 |
| temperature | | | | | | | | |
| (° C.) | | | | | | | | |
| heat treatment | 550 | 550 | 550 | 550 | 550 | 550 | [symbol] | [symbol] |
| temperature | | | | | | | | |
| (° C.) | | | | | | | | |
| BM-LLi mass | 3.04 ± 0.02 | 1.05 ± 0.03 | 2.05 ± 0.03 | [symbol] ± 0.03 | 2.06 ± 0.03 | 2.08 ± 0.02 | 2.07 ± 0.02 | [symbol] ± 0.03 |
| before heat | | | | | | | | |
| treatment | | | | | | | | |
| (m [symbol] ) | | | | | | | | |
| heat-treated | 2.87 ± 0.03 | [symbol] ± 0.04 | 1.99 ± 0.06 | 3.22 ± 0.04 | 1.91 ± 0.03 | 2.02 ± 0 | 2.78 ± 0.07 | 2.80 ± 0.05 |
| BM-LLi mass | | | | | | | | |
| ( [symbol] ) | | | | | | | | |
| BM-LLi | 94.39 ± 0.18 | 93.14 ± 0.98 | 96.92 ± 1.42 | 105.25 ± 0.35 | 92.54 ± 0.24 | 97.2 ± 0.82 | [symbol] | [symbol] ± 4.49 |
| recovery | | | | | | | | |
| rate % | | | | | | | | |

| i = Li, Al, | | | | | | | | |
|---|---|---|---|---|---|---|---|---|
| Mn, etc. | | | | | | | | |
| | heat-treated black mass | | | | | | | |
| | composition (wt. %):(x [symbol] ) | | | | | | | |
| Li | 3.8 ± 0.04 | 3.94 ± 0.05 | 3.98 ± [symbol] | [symbol] | 4.01 ± 0.09 | 3.96 ± 0.03 | 2.77 ± 0.01 | 2.71 ± 0.09 |
| Al | 0.73 ± 0.03 | 0.74 ± 0.01 | 0.75 ± 0.01 | 0.72 ± 0 | 0.8 ± 0.03 | 0.77 ± 0 | 0.55 ± 0.02 | 0.53 ± 0.07 |
| Mn | 6.36 ± 0.65 | 6.8 ± 0.16 | [symbol] ± 0.21 | 5.66 ± 0.12 | 7.02 ± 0.29 | 6.6 ± 0.07 | 4.42 ± 0.12 | 4.41 ± 0.18 |
| Co | 4.92 ± 0.41 | 5.23 ± 0.1 | 5.11 ± [symbol] | 4.45 ± 0.17 | 5.23 ± 0.13 | 5.14 ± 0.04 | 3.76 ± 0.01 | [symbol] ± 0.15 |
| Ni | 14.35 ± 1.17 | 15.42 ± 0.11 | 14.97 ± 0.31 | 13.13 ± 0.17 | [symbol] ± 0.05 | 14.91 ± 0.04 | 9.94 ± 0.21 | 10.12 ± 0.45 |
| Cu | 0.73 ± 0.04 | 0.71 ± 0.17 | [symbol] ± 0.01 | [symbol] ± 0.02 | 0.77 ± 0.03 | [symbol] ± 0.01 | 0.49 ± 0.02 | 0.45 ± 0.05 |
| | % retention rate _ [symbol] | | | | | | | |
| Li | [symbol] ± 0.33 | 94.13 ± [symbol] | 100.32 ± 1.33 | 95.97 ± 1.18 | 97.45 ± 1.1 | 99.65 ± 1.9 | [symbol] ± 1.94 | 95.02 ± [symbol] |
| Al | [symbol] ± 2.13 | 87.45 ± 2.27 | [symbol] ± 1.22 | 95.95 ± 0.01 | 96.29 ± 2.21 | 95.77 ± 1.12 | 98.11 ± 4.72 | 88.62 ± [symbol] |
| Mn | [symbol] ± 8.77 | 97.52 ± 1.25 | 100.45 ± 1.05 | 92.29 ± 1.81 | 100 ± 3.11 | 99.68 ± 2.19 | 93.1 ± 0.81 | 91.64 ± 3.65 |
| Co | [symbol] | 95.9 ± 0.79 | 98.73 ± 0.88 | 92.72 ± 3.39 | 98.3 ± 1.43 | 99.23 ± 1.87 | 99.1 ± 2.22 | 86.83 ± 3.92 |
| Ni | [symbol] | 94.72 ± 0.54 | 97.03 ± 0.05 | 91.77 ± 1.07 | 82.73 ± 0.74 | 96.54 ± 0.75 | 89.48 ± 0.25 | 90 ± 4.04 |
| Cu | 100 ± 7.1 | 93.35 ± 26.44 | 85.58 ± [symbol] | 93.71 ± 2.35 | 100 ± 2.44 | 86.53 ± 0.02 | 89.49 ± 5.08 | 85.62 ± [symbol] |

[symbol]

indicates data missing or illegible when filed

TABLE 7
Water leaching results for heat-treated BM-LLi.

| | | Cᵢ (mg/L) | | | | | | |
|---|---|---|---|---|---|---|---|---|
| | m_{BMHT}_{_{—}}ᵢ | V_{L} = 20 mL | mi^{L} | mi^{L} | mi^{L} | mi^{R} | % | |
| | (m_{BMHT} = 0.80 g) | (1^{st} wash) | (1^{st} wash) | (2^{nd}-3^{rd} wash) | total | (mg) | Leaching | αᵢ |
| AMC | | | | | | | | |
| Li | 30.59 ± 0.15 | 937.6 ± 39.03 | 18.75 ± 0.78 | 1.49 ± 0.28 | 20.24 ± 1.06 | 10.35 ± 0.91 | 66.17 | 95.69 |
| Al | 5.91 ± 0.03 | 81.06 ± 6.21 | 1.62 ± 0.12 | 1.87 ± 0.2 | 3.49 ± 0.08 | 2.42 ± 0.05 | 59.08 | 4.25 |
| Mn | 51.17 ± 0.25 | 0 ± 0 | 0 ± 0 | 0 ± 0 | 0 ± 0 | 51.17 ± 0.25 | 0.00 | 0.00 |
| Fe | 4.43 ± 0.02 | 0 ± 0 | 0 ± 0 | 0 ± 0 | 0 ± 0 | 4.43 ± 0.02 | 0.00 | 0.00 |
| Co | 39.6 ± 0.19 | 0 ± 0 | 0 ± 0 | 0 ± 0 | 0 ± 0 | 39.6 ± 0.19 | 0.00 | 0.00 |
| Ni | 115.45 ± 0.56 | 4.93 ± 6.97 | 0.1 ± 0.14 | 0.01 ± 0.02 | 0.11 ± 0.16 | 115.34 ± 0.72 | 0.10 | 0.06 |
| Cu | 5.91 ± 0.03 | 0 ± 0 | 0 ± 0 | 0 ± 0 | 0 ± 0 | 5.91 ± 0.03 | 0.00 | 0.00 |
| AMCR | | | | | | | | |
| Li | 31.67 ± 0.12 | 779.3 ± 5.09 | 15.59 ± 0.1 | 4.6 ± 0.15 | 20.18 ± 0.04 | 11.49 ± 0.08 | 63.72 | 97.46 |
| Al | 5.96 ± 0.02 | 47.81 ± 17.93 | 0.96 = 0.36 | 0.93 ± 0.06 | 1.89 ± 0.42 | 4.07 ± 0.44 | 31.64 | 2.34 |
| Mn | 54.66 ± 0.21 | 0 ± 0 | 0 ± 0 | 0 ± 0 | 0 ± 0 | 54.66 ± 0.21 | 0.00 | 0.00 |
| Fe | 4.35 ± 0.02 | 0 ± 0 | 0 ± 0 | 0 ± 0 | 0 ± 0 | 4.35 ± 0.02 | 0.00 | 0.00 |
| Co | 42.05 ± 0.16 | 0 ± 0 | 0 ± 0 | 0 ± 0 | 0 ± 0 | 42.05 ± 0.16 | 0.00 | 0.00 |
| Ni | 123.88 ± 0.47 | 5.18 ± 3.13 | 0.1 ± 0.06 | 0.25 ± 0.27 | 0.35 ± 0.33 | 123.53 ± 0.8 | 0.28 | 0.20 |
| Cu | 5.74 ± 0.02 | 0 ± 0 | 0 ± 0 | 0 ± 0 | 0 ± 0 | 5.74 ± 0.02 | 0.00 | 0.00 |
| AMF | | | | | | | | |
| Li | 31.92 ± 0.09 | 1,324.5 ± 17.68 | 26.49 ± 0.35 | 3.47 ± 0.73 | 29.96 ± 0.37 | 1.97 ± 0.28 | 93.84 | 97.53 |
| Al | 5.99 ± 0.02 | 95.8 ± 2.06 | 1.92 ± 0.04 | 1.03 ± 0.45 | 2.95 ± 0.5 | 3.04 ± 0.51 | 49.20 | 2.47 |
| Mn | 53.28 ± 0.16 | 0 ± 0 | 0 ± 0 | 0 ± 0 | 0 ± 0 | 53.28 ± 0.16 | 0.00 | 0.00 |
| Fe | 4.29 ± 0.01 | 0 ± 0 | 0 ± 0 | 0 ± 0 | 0 ± 0 | 4.29 ± 0.01 | 0.00 | 0.00 |
| Co | 41 ± 0.12 | 0 ± 0 | 0 ± 0 | 0 ± 0 | 0 ± 0 | 41 ± 0.12 | 0.00 | 0.00 |
| Ni | 120.08 ± 0.35 | 0 ± 0 | 0 ± 0 | 0 ± 0 | 0 ± 0 | 120.08 ± 0.35 | 0.00 | 0.00 |
| Cu | 4.99 ± 0.01 | 0 ± 0 | 0 ± 0 | 0 ± 0 | 0 ± 0 | 4.99 ± 0.01 | 0.00 | 0.00 |
| CAR | | | | | | | | |
| Li | 28.46 ± 0.03 | 1,188.5 ± 10.61 | 23.77 ± 0.21 | 1.92 ± 0.06 | 25.69 ± 0.15 | 2.77 ± 0.12 | 90.28 | 97.22 |
| Al | 5.76 ± 0.01 | 24.87 ± 3.49 | 0.5 ± 0.07 | 0.89 ± 0.01 | 1.38 ± 0.06 | 4.38 ± 0.06 | 24.01 | 1.35 |
| Mn | 45.59 ± 0.05 | 0 ± 0 | 0 ± 0 | 0 ± 0 | 0 ± 0 | 45.59 ± 0.05 | 0.00 | 0.00 |
| Fe | 3.66 ± 0 | 0 ± 0 | 0 ± 0 | 0 ± 0 | 0 ± 0 | 3.66 ± 0 | 0.00 | 0.00 |
| Co | 35.83 ± 0.04 | 0 ± 0 | 0 ± 0 | 0.01 ± 0.01 | 0.01 ± 0.01 | 35.83 ± 0.03 | 0.02 | 0.00 |
| Ni | 105.78 ± 0.11 | 144.7 ± 20.93 | 2.89 ± 0.42 | 0.3 ± 0.11 | 3.2 ± 0.53 | 102.58 ± 0.42 | 3.02 | 1.43 |
| Cu | 5.08 ± 0.01 | 0 ± 0 | 0 ± 0 | 0 ± 0 | 0 ± 0 | 5.08 ± 0.01 | 0.00 | 0.00 |
| AO | | | | | | | | |
| Li | [symbol] ± 0.01 | [symbol] | [symbol] ± 1.29 | 2.88 ± 1.25 | [symbol] ± 0.04 | 2.49 ± 0.08 | 92.15 | 99.43 |
| Al | 5.27 ± 0 | 20.33 ± 9.72 | 0.41 ± 0.19 | 0.24 ± 0.1 | [symbol] ± 0.29 | [symbol] ± 0.29 | 10.34 | 0.57 |
| Mn | 54.82 ± 0.01 | 0 ± 0 | 0 ± 0 | 0 ± 0 | 0 ± 0 | 54.82 ± 0.01 | 0.00 | 0.00 |
| Fe | [symbol] ± 0 | 0 ± 0 | 0 ± 0 | 0 ± 0 | 0 ± 0 | 4.8 ± 0 | 0.00 | 0.00 |
| Co | [symbol] ± 0.01 | 0 ± 0 | 0 ± 0 | 0 ± 0 | 0 ± 0 | [symbol] ± 0.01 | 0.00 | 0.00 |
| Ni | 119.08 ± 0.02 | 0 ± 0 | 0 ± 0 | 0 ± 0 | 0 ± 0 | 119.08 ± 0.02 | 0.00 | 0.00 |
| Cu | 6.06 ± 0 | 0 ± 0 | 0 ± 0 | 0 ± 0 | 0 ± 0 | 6.06 ± 0 | 0.00 | 0.00 |
| AA | | | | | | | | |
| Li | [symbol] ± 0.02 | 1,230.5 ± [symbol] | 24.81 ± 0.33 | 3.53 ± 0.01 | 28.14 ± 0.24 | 3.7 ± [symbol] | 88.39 | 98.82 |
| Al | [symbol] ± 0 | 25.36 ≤ 0.23 | 0.51 ± 0 | 0.8 ± 0.07 | 1.31 ± [symbol] | [symbol] ± 0.07 | 21.18 | 1.18 |
| Mn | [symbol] ± 0.08 | 0 ± 0 | 0 ± 0 | 0 ± 0 | 0 ± 0 | [symbol] ± [symbol] | 0.00 | 0.00 |
| Fe | 4.25 ± 0 | 0 ± 0 | 0 ± 0 | 0 ± 0 | 0 ± 0 | 4.25 ± 0 | 0.00 | 0.00 |
| Co | 41.37 ± [symbol] | 0 ± 0 | 0 ± 0 | 0 ± 0 | 0 ± 0 | 41.37 ± 0.03 | 0.00 | 0.00 |
| Ni | 119.94 ± 0.07 | 0 ± 0 | 0 ± 0 | 0.01 ± 0.01 | 0.01 ± 0.01 | 119.93 ± 0.06 | 0.01 | 0.00 |
| Cu | 5.07 ± 0 | 0 ± 0 | 0 ± 0 | 0 ± 0 | 0 ± 0 | 5.07 ± 0 | 0.00 | 0.00 |
| ACD | | | | | | | | |
| Li | 22.31 ± 0.05 | 881.05 ± 9.4 | 13.82 ± 0.19 | 2.82 ± [symbol] | 16.44 ± 0.04 | [symbol] | 73.71 | 99.00 |
| Al | 4.41 ± 0.01 | [symbol] ± 6.23 | 0.29 ± 0.12 | 0.35 ± 0.14 | 0.65 ± 0.26 | [symbol] ± 0.27 | [symbol] | 1.00 |
| Mn | 35.6 ± 0.07 | 0 ± 0 | 0 ± 0 | 0 ± 0 | 0 ± 0 | [symbol] ± 0.07 | 0.00 | 0.00 |
| Fe | 2.98 ± 0.01 | 0 ± 0 | 0 ± 0 | 0 ± 0 | 0 ± 0 | 2.98 ± 0.01 | 0.00 | 0.00 |
| Co | 30.31 ± 0.06 | 0 ± 0 | 0 ± 0 | 0 ± 0 | 0 ± 0 | 30.31 ± [symbol] | 0.00 | 0.00 |
| Ni | 80.15 ± 0.16 | 0 ± 0 | 0 ± 0 | 0 ± 0 | 0 ± 0 | 80.15 ± 0.16 | 0.00 | 0.00 |
| Cu | 3.94 ± 0.01 | 0 ± 0 | 0 ± 0 | 0 ± 0 | 0 ± 0 | [symbol] ± 0.01 | 0.00 | 0.00 |
| ACT | | | | | | | | |
| Li | 21.74 ± 0.01 | 557.46 ± 69.08 | 11.35 ± 1.38 | 4.37 ± 1.25 | 16.72 ± 0.14 | 6.02 ± 0.14 | 72.32 | [symbol] |
| Al | 4.22 ± 0 | 22.06 ± 0.19 | 0.44 ± 0 | 0.38 ± 0.06 | 0.82 ± 0.07 | 3.4 ± 0.06 | 19.44 | 1.32 |
| Mn | 35.43 ± 0.01 | 0 ± 0 | 0 ± 0 | 0 ± 0 | 0 ± 0 | 35.43 ± 0.01 | 0.00 | 0.00 |
| Fe | 2.99 ± 0 | 0 ± 0 | 0 ± 0 | 0 ± 0 | 0 ± 0 | 2.99 ± 0 | 0.00 | 0.00 |
| Co | 29.31 ≥ 0.01 | 0 ± 0 | 0 ± 0 | 0 ± 0 | 0 ± 0 | 29.31 ± 0.01 | 0.00 | 0.00 |
| Ni | 81.19 ± 0.02 | 0 ± 0 | 0 ± 0 | 0 ± 0 | 0 ± 0 | 81.19 ± 0.02 | 0.00 | 0.00 |
| Cu | 3.64 ± 0 | 0 ± 0 | 0 ± 0 | 0 ± 0 | 0 ± 0 | 3.64 ± 0 | 0.00 | 0.00 |

[symbol]

indicates data missing or illegible when filed

### Example 3

TABLE 8
Heat-treatment results for PS-HLi using various solid reducing agents.

| | Process scrap (PS-HLi) composition |
|---|---|
| | (wt. %) (xᵢ) |
| Li | 6.86 ± 0.143 |
| Al | 0.63 ± 0.021 |
| Mn | 3.84 ± 0.072 |
| Co | 2.94 ± 0.016 |
| Ni | 52.39 ± 0.750 |

| | reducing agent | | | | | |
|---|---|---|---|---|---|---|
| | AMF | CAR | AO | AA | ACD | ACT |
| reducing agent | 6 | 6 | 6 | 6 | 4 | 4 |
| addition mass | | | | | | |
| (g) | | | | | | |
| heat treatment | 550 | 550 | 550 | 550 | 550 | 550 |
| temperature | | | | | | |
| (° C.) | | | | | | |
| PS-HLi mass | 3.07 ± 0.01 | 3.02 ± 0.01 | 3.04 ± 0.01 | 3.07 ± 0.01 | 2.07 ± 0.01 | 2.06 ± 0.01 |
| before heat | | | | | | |
| treatment | | | | | | |
| (g) (m_{BM}) | | | | | | |
| heat-treated | 3.13 ± 0.01 | 3.08 ± 0.02 | 3.06 ± 0.01 | 3.22 ± 0.01 | 2.27 ± 0.01 | 2.40 ± 0.01 |
| PS-HLi mass | | | | | | |
| (g) (m_{BMHT}) | | | | | | |
| PS-HLi | 101.8 | 102 | 100.8 | 104.8 | 109.7 | 116.4 |
| recovery | | | | | | |
| rate % | | | | | | |

| i = Li, Al, | | | | | | |
|---|---|---|---|---|---|---|
| Mn, etc. | | | | | | |
| | heat-treated black mass | | | | | |
| | composition (wt. %): (xᵢ^{HT}) | | | | | |
| Li | 6.77 ± 0.17 | 6.78 ± 0.21 | 6.78 ± 0.15 | 6.76 ± 0.02 | 5.71 ± 0.07 | 6.04 ± 0.19 |
| Al | 0.61 ± 0.01 | 0.59 ± 0.02 | 0.62 ± 0.01 | 0.60 ± 0.01 | 0.50 ± 0.01 | 0.53 ± 0.01 |
| Mn | 3.59 ± 0.07 | 3.76 ± 0.11 | 3.55 ± 0.01 | 3.53 ± 0.02 | 3.06 ± 0.09 | 3.10 ± 0.11 |
| Co | 2.72 ± 0.01 | 2.84 ± 0.09 | 2.67 ± 0.01 | 2.68 ± 0.01 | 2.30 ± 0.01 | 2.33 ± 0.08 |
| Ni | 48.86 ± 0.42 | 51.25 ± 1.58 | 47.83 ± 0.46 | 48.38 ± 0.99 | 41.47 ± 0.71 | 43.30 ± 1.67 |
| | % retention rate_{_{—}}ᵢ | | | | | |
| Li | 99.00 ± 2.32 | 100.00 ± 0.45 | 100.00 ± 2.01 | 100.00 ± 0.09 | 94.45 ± 2.88 | 100.00 ± 5.39 |
| Al | 98.28 ± 1.51 | 94.90 ± 0.52 | 100.00 ± 0.65 | 100.00 ± 1.07 | 90.88 ± 0.90 | 100.00 ± 4.63 |
| Mn | 95.41 ± 1.54 | 97.95 ± 0.86 | 96.31 ± 0.48 | 97.29 ± 0.39 | 90.65 ± 4.42 | 98.56 ± 5.13 |
| Co | 94.63 ± 1.80 | 98.51 ± 0.58 | 94.69 ± 0.04 | 96.65 ± 0.29 | 88.82 ± 3.44 | 97.00 ± 4.98 |
| Ni | 95.20 ± 0.62 | 99.78 ± 1.55 | 95.05 ± 1.21 | 97.69 ± 1.83 | 89.90 ± 3.20 | 100 ± 5.71 |

A Li₂CO₃ precipitate was obtained in the same manner as described in Example 1, with the exception that PS-HLi was used in place of BM-MLi, with a composition detailed in Table 1. The results of the thermal reduction of BM-LLi using different reducing agents are presented in Table 8. Detailed leaching results for the heat-treated BM-LLi are shown in Table 9, while the precipitation efficiency and purity of the lithium carbonate are provided in Table 5.

TABLE 9
Water leaching results for heat-treated PS-HLi.

| | | Cᵢ (mg/L) | | | | | | |
|---|---|---|---|---|---|---|---|---|
| | m_{BMHT}_{_{—}}ᵢ | V_{L} = 30 mL | mi^{L} | mi^{L} | mi^{L} | mi^{R} | % | |
| | (m_{BMHT} = 1.20 g) | (1^{st} wash) | (1^{st} wash) | (2^{nd}-3^{rd} wash) | total | (mg) | Leaching | αᵢ |
| AMF | | | | | | | | |
| Li | 81.51 ± 0.07 | 2,472.6 ± [symbol] | 74.18 ± 1.04 | 4.54 ± 1.19 | 78.71 ± 0.15 | 2.8 ± 0.08 | 96.57 | 99.81 |
| Al | 7.29 ± 0.01 | 19.89 ± 2.88 | 0.60 ± 0.09 | 0 ± 0 | 0.60 ± 0.04 | 6.69 ± 0.03 | 8.19 | 0.19 |
| Mn | 43.2 ± 0.04 | 0 ± 0 | 0 ± 0 | 0 ± 0 | 0 ± 0 | 43.14 ± 1.35 | 0.00 | 0.00 |
| Co | 32.78 ± 0.03 | 0 ± 0 | 0 ± 0 | 0 ± 0 | 0 ± 0 | 32.63 ± 0.84 | 0.00 | 0.00 |
| Ni | 588.48 ± 0.52 | 0 ± 0 | 0 ± 0 | 0 ± 0 | 0 ± 0 | 587.93 ± 5.09 | 0.00 | 0.00 |
| CAR | | | | | | | | |
| Li | 151.46 ± 10.12 | 2,318 ± 87.68 | 127.65 ± 13 | 23.82 ± 2.89 | 149.30 ± 9.96 | 2.18 ± 0.14 | 98.57 | 99.65 |
| Al | 12.91 ± 0.86 | 36.17 ± 9.69 | 2.08 ± 0.90 | 0 ± 0 | 2.01 ± 0.14 | 10.83 ± 0.72 | 15.57 | 0.35 |
| Mn | 82.83 ± 5.54 | 0 ± 0 | 0 ± 0 | 0 ± 0 | 0 ± 0 | 82.82 ± 5.41 | 0.00 | 0.00 |
| Co | 62.53 ± 4.18 | 0 ± 0 | 0 ± 0 | 0 ± 0 | 0 ± 0 | 62.52 ± 4.13 | 0.00 | 0.00 |
| Ni | 1,128.71 ± 75.43 | 0 ± 0 | 0 ± 0 | 0 ± 0 | 0 ± 0 | 1,128.46 ± 84 | 0.00 | 0.00 |
| AO | | | | | | | | |
| Li | 81.69 ± 0.04 | [symbol] ± 36.77 | 73.29 ± 1.1 | 5.62 ± 1.05 | 78.91 ± 0.05 | 2.78 ± 0.09 | 96.60 | 99.97 |
| Al | 7.49 ± 0 | 37.85 ± 1.89 | 1.14 ± 0.06 | 0 ± 0 | 0.11 ± 0.01 | 7.39 ± 0.01 | 1.42 | 0.03 |
| Mn | 42.73 ± 0.02 | 0 ± 0 | 0 ± 0 | 0 ± 0 | 0 ± 0 | 42.9 ± 1.02 | 0.00 | 0.00 |
| Co | 32.18 ± 0.02 | 0 ± 0 | 0 ± 0 | 0 ± 0 | 0 ± 0 | 32.55 ± 0.8 | 0.00 | 0.00 |
| Ni | 576.42 ± 0.27 | 0 ± 0 | 0 ± 0 | 0 ± 0 | 0 ± 0 | [symbol] ± 18.23 | 0.00 | 0.00 |
| AA | | | | | | | | |
| Li | 68 ± 0.25 | [symbol] ± 48.08 | 58.45 ± 1.2 | 8.64 ± 0.97 | [symbol] ± 0.23 | 0.91 ± 0.02 | 98.66 | 99.83 |
| Al | 6.07 ± 0.02 | 18.27 ± [symbol] | 0.45 ± 0.12 | 0 ± 0 | 0.46 ± 0.16 | 5.62 ± 0.14 | 7.52 | 0.17 |
| Mn | 35.5 ± 0.13 | 0 ± 0 | 0 ± 0 | 0 ± 0 | 0 ± 0 | 34.92 ± 0.62 | 1.62 | 0.00 |
| Co | 26.91 ± 0.1 | 0 ± 0 | 0 ± 0 | 0 ± 0 | 0 ± 0 | 26.89 ± 0.74 | 0.07 | 0.00 |
| Ni | [symbol] ± 1.78 | 0 ± 0 | 0 ± 0 | 0 ± 0 | 0 ± 0 | 486.16 ± 7.94 | 0.10 | 0.00 |
| ACD | | | | | | | | |
| Li | 57.36 ± 0.13 | 2,101 ± 127.28 | [symbol] ± 3.18 | 3.17 ± 3.03 | 55.7 ± 0.15 | 1.66 ± 0.27 | 97.11 | 100.00 |
| Al | 5.05 ± 0.01 | 0 ± 0 | 0 ± 0 | 0 ± 0 | 0 ± 0 | 5.16 ± 0.02 | 0.00 | 0.00 |
| Mn | 30.73 ± 0.07 | 0 ± 0 | 0 ± 0 | 0 ± 0 | 0 ± 0 | 30.59 ± 0.24 | 0.00 | 0.00 |
| Co | 23.07 ± 0.05 | 0 ± 0 | 0 ± 0 | 0 ± 0 | 0 ± 0 | 23.35 ± 0.01 | 0.00 | 0.00 |
| Ni | [symbol] ± 0.91 | 0 ± 0 | 0 ± 0 | 0 ± 0 | 0 ± 0 | 416.06 ± 3.31 | 0.00 | 0.00 |
| ACT | | | | | | | | |
| Li | [symbol] ± 0.02 | 2,089 ± 130.11 | 52.23 ± 3.25 | 6.9 ± 3.35 | 59.12 ± 0.1 | 1.72 ± 0.12 | 97.17 | 99.82 |
| Al | [symbol] ± 0 | 16.7 ± 19.65 | 0.42 ± 0.49 | 0 ± 0 | 0.42 ± 0.28 | 4.92 ± 0.28 | 7.83 | 0.18 |
| Mn | [symbol] ± 0.01 | 0 ± 0 | 0 ± 0 | 0 ± 0 | 0 ± 0 | 31.17 ± 0.47 | 3.37 | 0.00 |
| Co | 23.5 ± 0.01 | 0 ± 0 | 0 ± 0 | 0 ± 0 | 0 ± 0 | 23.62 ± 0.36 | 3.75 | 0.00 |
| Ni | 435.84 ± 0.15 | 0 ± 0 | 0 ± 0 | 0 ± 0 | 0 ± 0 | 435.51 ± 7.01 | 0.31 | 0.00 |

[symbol]

indicates data missing or illegible when filed

### Example 4

A precipitate (i.e., Li₂CO₃) was obtained in the same manner and conditions as in Example 1, except that other cathode materials LMO, LCO and NCA were used instead of BM-MLi, which was the LIB waste cathode material containing an NCM active material of Example 1. The water leaching results of the various heat-treated cathode materials are shown in Table 10.

TABLE 10
Water leaching results for other cathode materials heat-treated with various reducing agents.

| | | | | | | | |
|---|---|---|---|---|---|---|---|
| | Cᵢ (mg/L) | | | | | | |
| m_{BMHT}_{_{—}}ᵢ | V_{L} = 20 mL | mi^{L} | mi^{L} | mi^{L} | mi^{R} | % | |
| (m_{BMHT} = 0.8 g) | (1^{st} wash) | (1^{st} wash) | (2^{nd}-3^{rd} wash) | total | (mg) | Leaching | αᵢ |

LMO Cathode: LiMnO₂

| | | | | | | | | |
|---|---|---|---|---|---|---|---|---|
| AMF | | | | | | | | |
| Li | 53.02 ± 0.11 | 2,475.5 ± 96.87 | 49.51 ± 1.94 | 3.15 ± 1.88 | 52.66 ± 0.06 | 0.36 ± 0.05 | 99.32 | 100.00 |
| Mn | 400.02 ± 0.81 | 0 ± 0 | 0 ± 0 | 0 ± 0 | 0 ± 0 | 400.02 ± 0.81 | 0.00 | 0.00 |
| CAR | | | | | | | | |
| Li | 47.36 ± 0.2 | 2,187.5 ± 61.52 | 43.75 ± 1.23 | 0.02 ± 1.8 | 43.77 ± 0.57 | 3.59 ± 0.38 | 92.43 | 100.00 |
| Mn | 358.83 ± 1.48 | 0 ± 0 | 0 ± 0 | 0 ± 0 | 0 ± 0 | 358.83 ± 1.48 | 0.00 | 0.00 |
| AO | | | | | | | | |
| Li | 54.14 ± 0.39 | 2,426.5 ± 40.31 | 48.53 ± 0.81 | 3.3 ± 0.96 | 51.83 ± 0.16 | 2.31 ± 0.54 | 95.73 | 99.99 |
| Mn | 409.88 ± 2.92 | 0 ± 0 | 0 ± 0 | 0.02 ± 0.03 | 0.02 ± 0.03 | 409.85 ± 2.89 | 0.01 | 0.01 |
| AA | | | | | | | | |
| Li | 52.68 ± 0.01 | 2,453 ± 8.49 | 49.06 ± 0.17 | 3.25 ± 0.18 | 52.31 ± 0.01 | 0.37 ± 0.02 | 99.30 | 100.00 |
| Mn | 398.85 ± 0.11 | 0 ± 0 | 0 ± 0 | 0 ± 0 | 0 ± 0 | 398.85 ± 0.11 | 0.00 | 0.00 |

LCO Cathode: LiCoO₂

| AMF | | | | | | | | |
|---|---|---|---|---|---|---|---|---|
| Li | 62.91 ± 0.11 | 2,590.5 ± 142.13 | 51.81 ± 2.84 | 9.05 ± 2.52 | 60.86 ± 0.32 | 2.06 ± 0.43 | 96.73 | 100.00 |
| Mn | 452.43 ± 0.8 | 0 ± 0 | 0 ± 0 | 0 ± 0 | 0 ± 0 | 452.43 ± 0.8 | 0.00 | 0.00 |
| CAR | | | | | | | | |
| Li | 64.78 ± 0.21 | 2,485.5 ± 14.85 | 49.71 ± 0.3 | 13.98 ± 0.12 | 63.69 ± 0.42 | 1.09 ± 0.63 | 98.31 | 100.00 |
| Mn | 458.81 ± 1.49 | 0 ± 0 | 0 ± 0 | 0 ± 0 | 0 ± 0 | 458.81 ± 1.49 | 0.00 | 0.00 |
| AO | | | | | | | | |
| Li | 62.44 ± 0.03 | 2,437.5 ± 197.28 | 48.75 ± 3.95 | 12.21 ± 5.09 | 60.96 ± 1.15 | 1.48 ± 1.11 | 97.63 | 99.99 |
| Mn | 439.77 ± 0.23 | 0 ± 0 | 0 ± 0 | 0.04 ± 0.06 | 0.04 ± 0.06 | 439.73 ± 0.17 | 0.01 | 0.01 |
| AA | 62.44 ± 0.03 | 2,437.5 ± 197.28 | 48.75 ± 3.95 | 12.21 ± 5.09 | 60.96 ± 1.15 | 1.48 ± 1.11 | 97.63 | 99.99 |
| Li | 58.25 ± 0.12 | 2,388.5 ± 178.9 | 47.77 ± 3.58 | 5.62 ± 0.56 | 53.39 ± 4.14 | 4.86 ± 4.02 | 91.66 | 99.94 |
| Mn | 431.43 ± 0.87 | 0 ± 0 | 0 ± 0 | 0.26 ± 0.37 | 0.26 ± 0.37 | 431.18 ± 0.51 | 0.06 | 0.06 |
| | LMO Cathode: LiMn₂O₄ | | | | | | | |
| AMF | | | | | | | | |
| Li | 18.71 ± 0.11 | 1,283.1 ± 438.26 | [symbol] ± 8.77 | 0 ± 0 | 18.54 ± 0.05 | 0.17 ± 0.04 | 99.11 | 100.00 |
| Mn | 295.76 ± 1.7 | 0 ± 0 | 0 ± 0 | 0 ± 0 | 0 ± 0 | 295.76 ± 1.7 | 0.00 | 0.00 |
| CAR | | | | | | | | |
| Li | 27.78 ± 0.02 | 1,383.5 ± 184.55 | 27.67 ± 3.69 | 0 ± 0 | 24.67 ± 1.6 | 3.11 ± 1.58 | 88.80 | 99.95 |
| Mn | 437.31 ± 0.38 | 0 ± 0 | 0 ± 0 | 0.09 ± 0.13 | 0.09 ± 0.13 | 437.22 ± 0.51 | 0.02 | 0.05 |
| AO | | | | | | | | |
| Li | 30.68 ± 0.01 | 1,171 ± 69.3 | 23.42 ± 1.39 | 0 ± 0 | 23.09 ± 0.28 | 7.58 ± 0.26 | 75.28 | 100.00 |
| Mn | 479.16 ± 0.21 | 0 ± 0 | 0 ± 0 | 0 ± 0 | 0 ± 0 | 479.16 ± 0.21 | 0.00 | 0.00 |
| AA | | | | | | | | |
| Li | 30.79 ± 0.15 | 1,406.5 ± 106.77 | 28.13 ± 2.14 | 0 ± 0 | 26.87 ± 1.59 | 3.92 ± 1.75 | 87.27 | 100.00 |
| Mn | 480.73 ± 2.36 | 0 ± 0 | 0 ± 0 | 0 ± 0 | 0 ± 0 | 480.73 ± [symbol] | 0.00 | 0.00 |
| | NCA Cathode: Li(Ni_{0.80}Co_{0.15}Al_{0.05})O₂ | | | | | | | |
| AMF | | | | | | | | |
| Li | 57.17 ± 0.21 | 2334.5 ± 20.51 | 46.69 ± 0.41 | 0.89 ± 0 | 47.58 ± 0.54 | 10.48 ± 0.33 | 83.22 | 99.75 |
| Al | 6.28 ± 0.02 | 23.59 ± 4 | 0.47 ± 0.08 | 0 ± 0 | 0.47 ± 0.08 | 5.81 ± 0.06 | 7.51 | 0.25 |
| Mn | 13.19 ± 0.05 | 0 ± 0 | 0 ± 0 | 0 ± 0 | 0 ± 0 | 13.19 ± 0.05 | 0.00 | 0.00 |
| Co | 60.68 ± 0.22 | 0 ± 0 | 0 ± 0 | 0 ± 0 | 0 ± 0 | 60.68 ± 0.22 | 0.00 | 0.00 |
| Ni | 392.01 ± 1.45 | 0 ± 0 | 0 ± 0 | 0 ± 0 | 0 ± 0 | 392.01 ± 1.45 | 0.00 | 0.00 |
| CAR | | | | | | | | |
| Li | 54.24 ± 0.17 | 2448 ± 52.33 | 48.96 ± 1.05 | 0 ± 0 | 47.01 ± 0.23 | 7.23 ± 0.06 | 86.67 | 98.91 |
| Al | 6.08 ± 0.02 | 9.67 ± 10.84 | 0.19 ± 0.22 | 0 ± 0 | 1.24 ± 0.1 | 4.85 ± 0.08 | 20.33 | 0.67 |
| Mn | 12.72 ± 0.04 | 0 ± 0 | 0 ± 0 | 0 ± 0 | 0 ± 0 | 12.72 ± 0.04 | 0.00 | 0.00 |
| Co | 54.3 ± 0.17 | 5.78 ± 7.08 | 0.12 ± 0.14 | 0 ± 0 | 0.12 ± 0.14 | 54.18 ± 0.31 | 0.21 | 0.03 |
| Ni | 372.83 ± 1.18 | 79.7 ± 112.71 | 1.59 ± 2.25 | 0 ± 0 | 1.59 ± 2.25 | 371.24 ± 3.43 | 0.43 | 0.40 |
| AO | | | | | | | | |
| Li | 56.45 ± 0.03 | 2447 ± 62.23 | 48.94 ± 1.24 | 5.61 ± 1.55 | 54.55 ± 0.3 | 1.9 ± 0.34 | 96.63 | 100.00 |
| Al | 6.13 ± 0 | 0 ± 0 | 0 ± 0 | 0 ± 0 | 0 ± 0 | 6.13 ± 0 | 0.00 | 0.00 |
| Mn | 12.88 ± 0.01 | 0 ± 0 | 0 ± 0 | 0 ± 0 | 0 ± 0 | 12.88 ± 0.01 | 0.00 | 0.00 |
| Co | 55.02 ± 0.03 | 0 ± 0 | 0 ± 0 | 0 ± 0 | 0 ± 0 | 55.02 ± 0.03 | 0.00 | 0.00 |
| Ni | 378.22 ± 0.23 | 0 ± 0 | 0 ± 0 | 0 ± 0 | 0 ± 0 | 378.22 ± 0.23 | 0.00 | 0.00 |
| AA | | | | | | | | |
| Li | 57.79 ± 0.07 | 2446 ± 42.43 | 48.92 ± 0.85 | 0 ± 0 | 48.92 ± 0.02 | 8.87 ± 0.09 | 84.65 | 100.00 |
| Al | 5.85 ± 0.01 | 0 ± 0 | 0 ± 0 | 0 ± 0 | 0 ± 0 | 5.85 ± 0.01 | 0.00 | 0.00 |
| Mn | 13.3 ± 0.02 | 0 ± 0 | 0 ± 0 | 0 ± 0 | 0 ± 0 | 13.3 ± 0.02 | 0.00 | 0.00 |
| Co | 58.67 ± 0.07 | 0 ± 0 | 0 ± 0 | 0 ± 0 | 0 ± 0 | 58.67 ± 0.07 | 0.00 | 0.00 |
| Ni | 387.92 ± 0.48 | 0 ± 0 | 0 ± 0 | 0 ± 0 | 0 ± 0 | 387.92 ± 0.48 | 0.00 | 0.00 |

[symbol]

indicates data missing or illegible when filed

### Experimental Examples

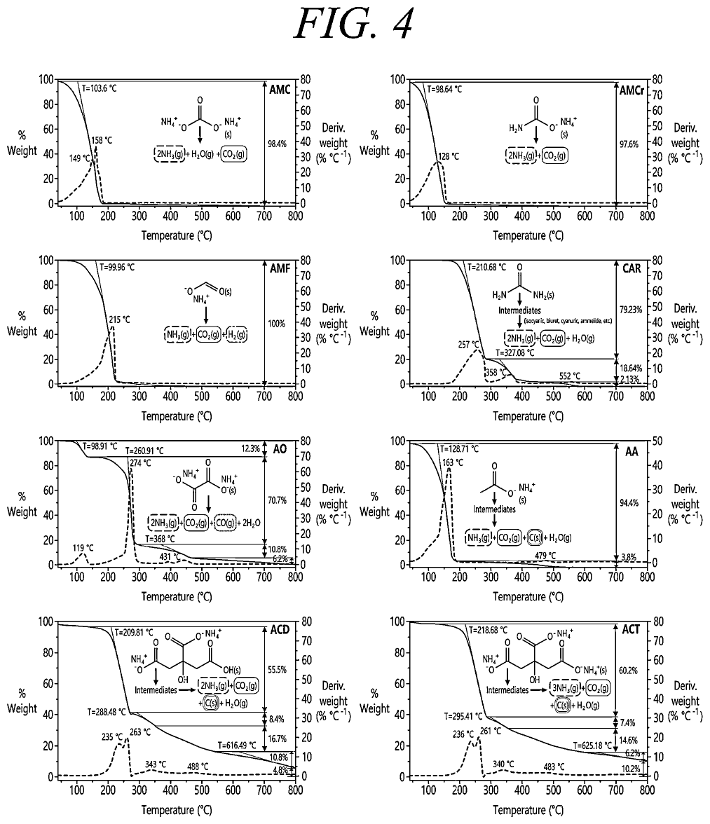

Results from thermogravimetric (TGA) analysis and differential-TG curves (20° C. min⁻¹, N₂ gas) of the solid agents used as reducing gas carriers listed in Table 2 are shown in FIG. 4. It was confirmed that AMC generates NH₃ and CO₂ gases at 158° C., AMCR produces NH₃ and CO₂ gases at 128° C., and AMF generates NH₃, CO₂, and H₂ gases at 215° C. Furthermore, specific reducing agents like CAR, which exhibits maximum weight loss at 257° C., 358° C., and 552° C., and AO, which shows maximum weight loss at 119° C., 274° C., and 431° C., undergo two or three stages of mass loss. This behavior is attributed to the formation of intermediates before the complete decomposition of the reducing agent, resulting in the generation of reducing gases. Additionally, it was confirmed that reducing agents such as AA, ACD, and ACT generate char (C) in addition to the reducing gases NH₃ and CO₂.

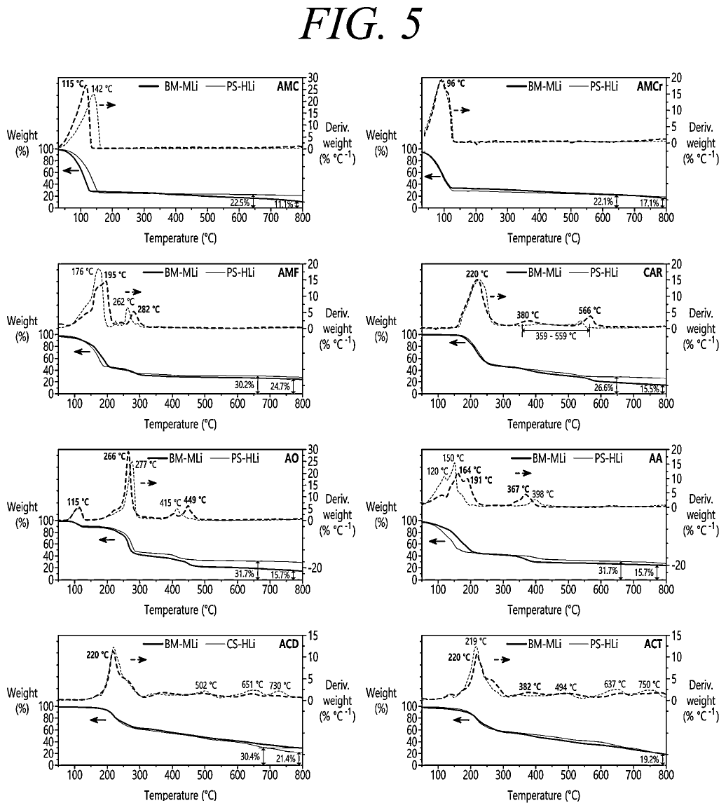

Results from thermogravimetric (TGA) analysis and differential-TG curves (20° C. min⁻¹, N₂ gas) of the mixtures BM-MLi or PS-HLi with reducing agents with a mass ratio of 1:2 are shown in FIG. 5. It was confirmed that the solid mixtures exhibit a lower derivative weight temperature compared to their pure reducing agent counterparts (see FIG. 4), indicating the effect of the presence of the LIB waste cathode in the thermal degradation of the reducing agents. The reduction reaction may not be observed in the case of AMC and AMCR due to their low thermal degradation temperatures; they did not exhibit any distinct change in derivative weight peak. In contrast, AMF, CAR, AO, AA, ACD, and ACT exhibit changes such as peak shifts and/or additional derivative weight peaks at higher temperatures. A final thermochemical reduction temperature may range from 300 to 700° C., specifically, from 500 to 600° C. for efficient reduction and actual operation.

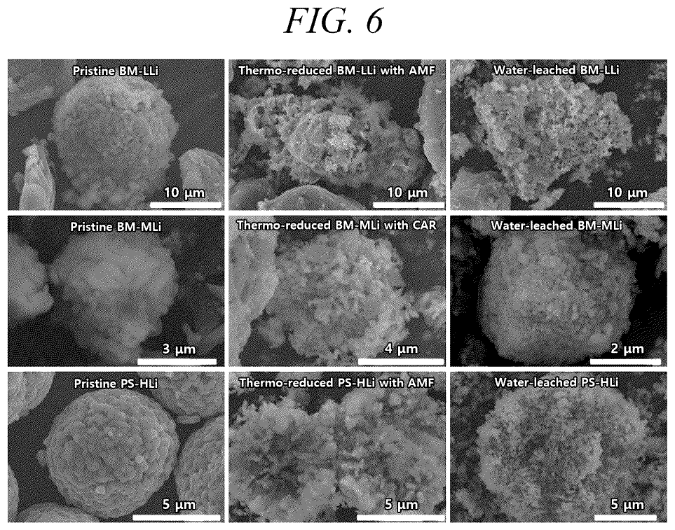

SEM images of BM-LLi, BM-MLi, and PS-HLi before heat treatment (pristine state), after the heat treatment, and after water leaching are shown in FIG. 6 The polyhedral structures of cathode materials BM-LLi, BM-MLi or PS-HLi are initially observed as primary particles, which aggregate into larger clusters or compact spheroids, forming secondary particles. As gases evolve during the reduction of transition metal oxides to lower-valent oxides or elemental metals, the well-defined compact structure of the cathode active material disintegrates, resulting in a less dense and highly disordered morphology in the heat treated BM-LLi, BM-MLi or PS-HLi. This process also leads to increased porosity in the cathode materials within BM-LLi, BM-MLi or PS-HLi as the MeO₂ sheets are broken down.

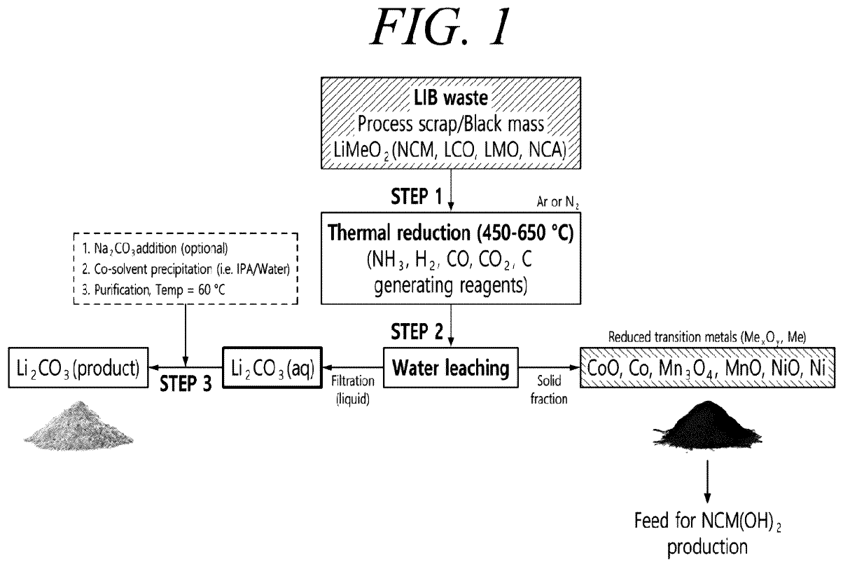

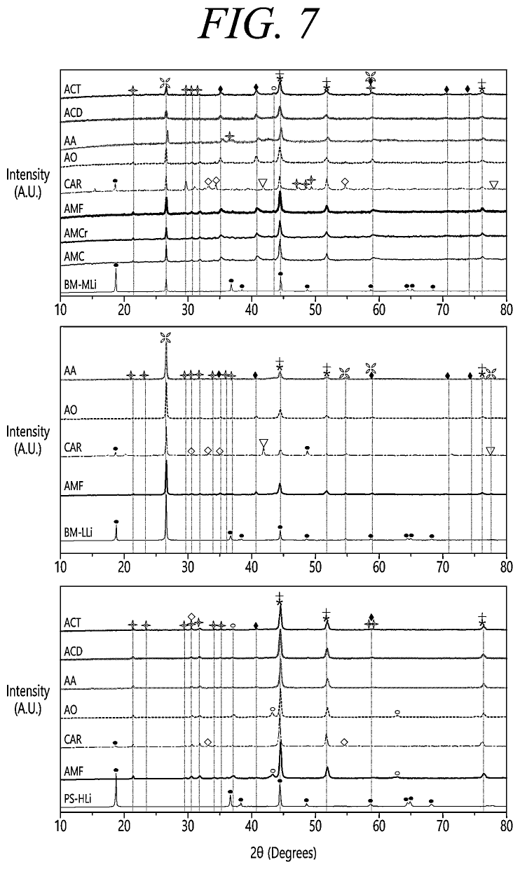

The efficient reduction process of the LIB waste by the reducing gas discharged from the reducing agent may be observed in the XRD patterns of the heat-treated black masses BM-MLi, BM-LLi and process scrap PS-HLi, as shown in FIG. 7. The XRD patterns of BM-MLi, BM-LLi, and PS-HLi are completely altered after heat treatment using different reducing agents. The XRD patterns indicate that the dominant reduction products are metallic Co, Ni, MnO except for certain agents where minor presence of low-valent metal oxides CoO and NiO were also observed (FIG. 1). Thus, certain agents like AO and AMF in PS-HLi and ACT in BM-MLi have partially reduced and fully reduced transition metals.

The transition metal oxides separate Li from other metals by forming Li₂O simultaneously with reduction. However, it can be confirmed that Li₂O readily reacts with CO₂ gas that was generated during heat treatment to form Li₂CO₃, as reflected in the XRD patterns of all heat-treated samples that exhibit peaks for Li₂CO₃.

After heat treatment, the BM-MLi, BM-LLi and PS-HLi were expected to experience weight loss due to removal of O from the transition metal oxides, volatilization of electrolytes, and conducting salts in the LIB wastes. However, the insertion of CO₂ into Li₂O partially offsets the mass loss. As summarized in Tables 3, 6, and 8, the total mass loss did not exceed 20% for the BM and PS samples that have been heat-treated with AMC, AMCR, AMCR, AFM, CAR, and AO. Meanwhile, BM and PS samples heat-treated with AA, ACD, and ACT exhibited a mass increase because the reducing agents were not completely decomposed and promoted the formation of char C.

Considering that the heat treatment of the LIB wastes occurs at temperatures lower than 700° C., the amount of the elements of interest (i=Li, Ni, Co, Mn) is expected to be the same before (m_{BM-i}) and after (m_{BMHT-i}) heat treatment as in Equation 1. A m_{BM-i} value may be experimentally determined by multiplying the mass fraction of element i (xᵢ) by the feed mass of BM or PS (m_{BM}), and m_{BMHT-i} is calculated from the mass fraction of element i (xᵢ^{HT}) in the heat-treated LIB waste cathode material (m_{BMHT}).

$${m}_{BM - i} = {m}_{BMHT - i} ; {m}_{BM} \times {x}_{i} = {m}_{BMHT} \times {x}_{i}^{HT} \qquad Equation 1$$

The retention of elements before and after heat treatment can be experimentally confirmed using Equation 2, and Equation 2 is represented by the retention % of element i (% retention_i). This is simply a mass ratio of elements in the LIB waste cathode materials before and after heat treatment.

$$\% {retention}_{i} = \frac{{m}_{BMHT - i}}{{m}_{BM - i}} \times 100 = \frac{{m}_{BMHT} \times {x}_{i}^{HT}}{{m}_{BM} \times {x}_{i}} \times 100 \qquad Equation 2$$

The retention of elements is clearly observed in most of the heat-treated LIB waste BM-MLi, BM-LLi and PS-HLi (see Tables 3, 6, and 8). While samples with reduced mass showed higher xᵢ^{HT} after heat treatment, samples with increased mass showed lower xᵢ^{HT}. Most of the heat-treated samples showed very high % retention of elements, and some samples achieved 100%. On the other hand, specific measured values were lower than expected (e.g., ˜88% to 90% retention). This may be associated with the heterogeneity of the heat-treated LIB wastes as the reduced transition metals tend to form clusters. The non-uniform element distribution caused a difference in analytical values.

The present disclosure relates to thermally treating the LIB wastes using different types of solid reducing agents and then separating Li⁺ as Li₂CO₃ from the solid

LIB wastes through water leaching. The water leaching may adjust the amount of water added depending on the expected amount of Li⁺ in the heat-treated LIB wastes.

The leaching efficiency of element i in the heat-treated LIB waste cathode materials can be calculated using Equation 3 or 4, while the leaching selectivity αᵢ of element i (Li, Al, Mn, Co, Ni, or Cu) is determined using Equation 6. Here, mᵢ^{L} represents the mass of the leached element i, Cᵢ denotes the initial concentration of element i in the leaching solution, V_{L} is the volume of the leaching solution. The mass of element i in the heat-treated LIB waste cathode material is represented by m_{BMHT-i} while mᵢ^{R} indicates the mass of element i in the solid component of the heat-treated LIB water cathode material recovered after water leaching. The mass fraction of element i after heat treatment is denoted by xᵢ^{HT}, with m_{BMHT} representing the mass of the LIB waste cathode material post-heat treatment. The mass of the residual solids of the heat-treated LIB waste cathode material recovered after water leaching is denoted by m^{R}_{BMHT} and xᵢ^{R} denotes the mass fraction of element i in the residual solids with mass m^{R}_{BMHT}. Additionally, mᵢ^{L}, represents the number of moles of element i in the leaching solution, and At._massᵢ stands for the atomic mass of element i (atomic mass as g mole⁻¹; Li=6.941, Ni=58.693, Co=58.933, Mn=54.938, Al=26.982, Fe=55.845, Cu=65.546).

$$\% {Leaching}_{\_ i} = \frac{{m}_{i}^{L}}{{m}_{BMHT - i}} \times 100 \% = \frac{{C}_{i} {V}_{L}}{{m}_{BMHT - i}} \times 100 \% = \frac{( {m}_{BMHT - i} - {m}_{i}^{R} )}{{m}_{BMHT - i}} \times 100 \% ; \qquad Equation 3$$

$$\% {Leaching}_{\_ i} = \frac{( {m}_{BMHT} \times {x}_{i}^{HT} - {m}_{BMHT}^{R} \times {x}_{i}^{R} )}{{m}_{BMHT} \times {x}_{i}^{HT}} \times 100 \% \qquad Equation 4$$

$${m}_{i}^{R} = {m}_{BMHT}^{R} \times {x}_{i}^{R} \qquad Equation 5$$

$${α}_{i} = \frac{{m}_{i}^{{L}^{′}}}{\sum {m}_{i}^{{L}^{′}}} \times 100 \% = \frac{( {m}_{BMHT} \times {x}_{i}^{HT} - {m}_{BMHT}^{R} \times {x}_{i}^{R} ) / At . {\_mass}_{i}}{\sum {m}_{i}^{{L}^{′}}} \times 100 \% \qquad Equation 6$$

The heat-treated LIB waste cathode materials listed in Tables 3, 6, and 8 selectively recovered Li⁺ as shown in FIG. 8. The Li⁺ leaching efficiencies in BM-MLi ranged 69-89% whereas that of BM-LLi ranged 63-94% and PS-HLi >96.5% but all thermally treated LIB wastes exhibit αᵢ>95%.

Aside from the conditions during heat-treatment, other factors such as a heat treatment temperature, a heat treatment holding time, and a mixing ratio of the reducing agent and the LIB waste should be adjusted to maximize the selective leaching efficiency of lithium ions.

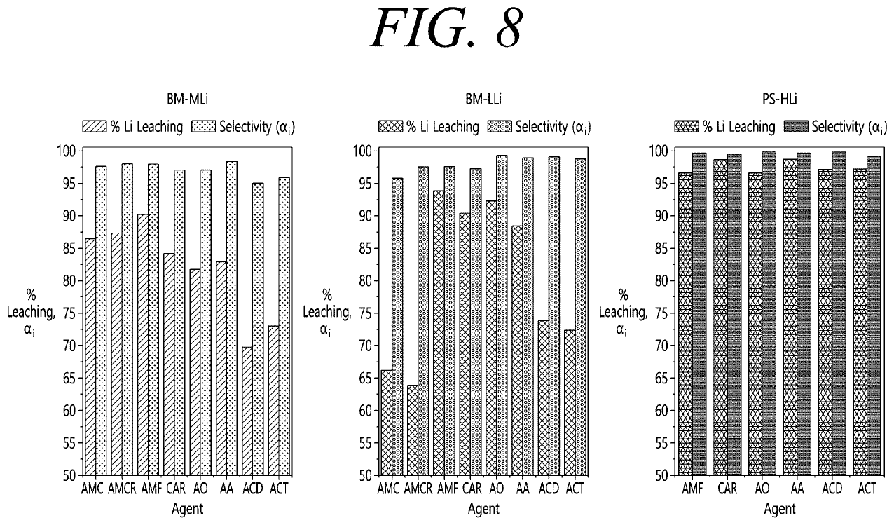

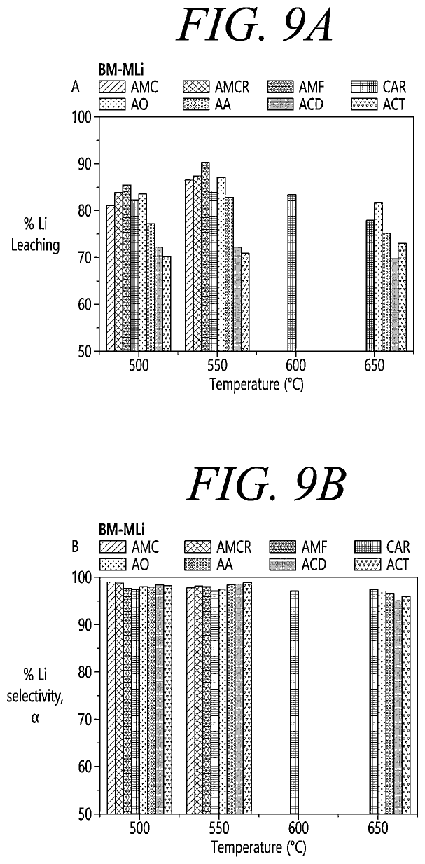

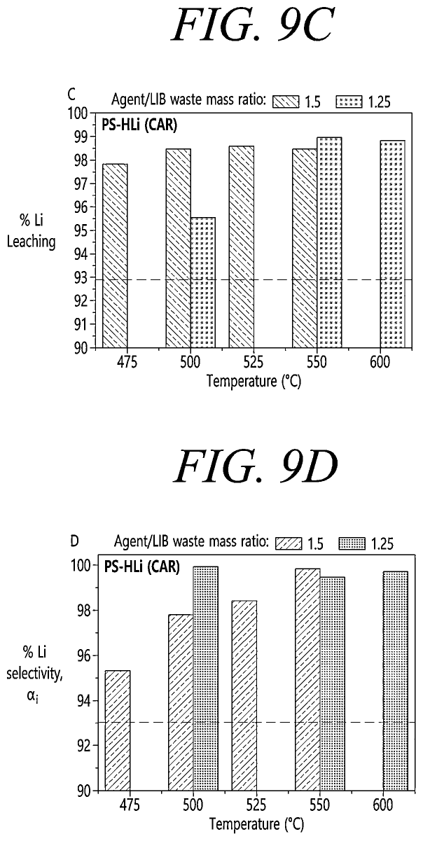

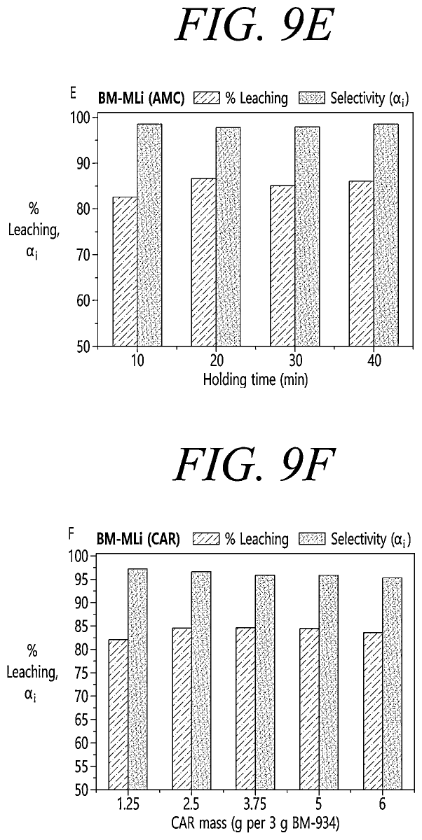

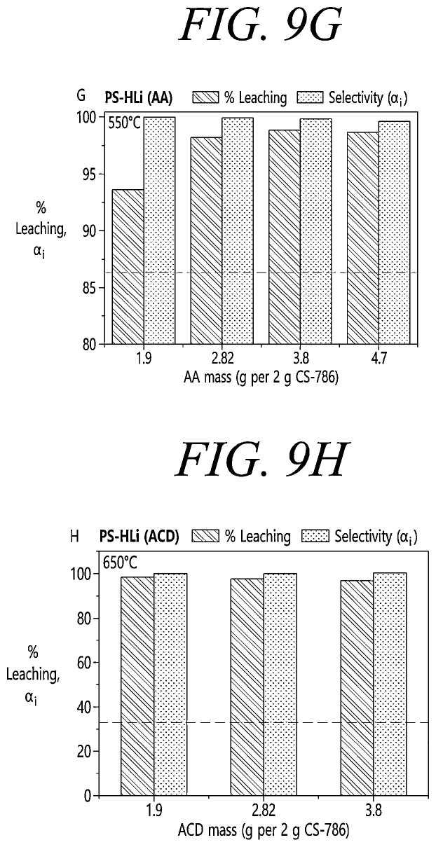

Among the above-mentioned factors, the heat treatment temperature is the most important factor to consider because sufficient heat energy is required to initiate reduction depending on the type of LIB waste cathode material and reducing agent. Referring to FIG. 9, among the tested LIB waste cathode materials and solid agents, final temperatures between 500-650° C. preferably 550°° C. showed the best outcomes for Li leaching efficiency (FIGS. 9A and 9C). Regardless of the temperature, the LIB waste cathode materials treated with various types of reducing agents achieved high leaching selectivity for Li ions α_{Li}>95% (see FIGS. 9B and 9D).

At the optimal heat treatment temperature, the reduction process occurs rapidly within 5 to 40 minutes, but it is preferable to proceed with the reaction for 20 to 30 minutes to achieve maximum Li⁺ leaching efficiency (see FIG. 9E). Likewise, at the optimal heat treatment temperature, satisfactory % Li⁺ leaching efficiency can be provided even at a mass ratio as low as 0.42 (1.25 g of agent to 3 g of LIB waste cathode material) (see FIG. 9F).

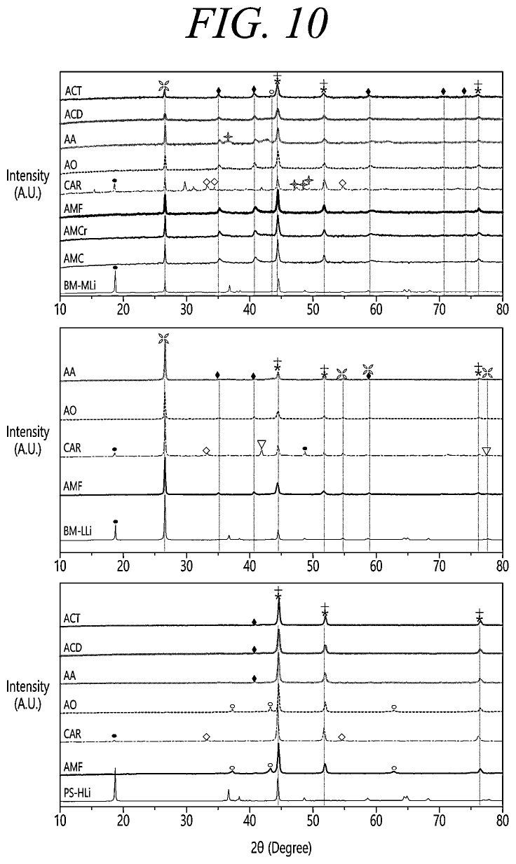

The XRD patterns of the LIB waste cathode materials after water leaching (see FIG. 10), the peaks associated with Li₂CO₃ disappear because Li₂CO₃ has been effectively eluted. The patterns also showed that the sharp peaks corresponding to the reduced metals (in their low-valent or zero-valent states) were retained, indicating that these metals were not dissolved in water.

During leaching, specific anions may be co-eluted into the water along with the aqueous Li₂CO₃. For example, black mass usually contains low levels of F− and Cl− depending on the characteristics of the LIB wastes. The water leaching solution may occasionally contain trace levels of NO₃₋ and SO₄²⁻. Therefore, although Li⁺ has CO₃²⁻ as its major counter anion, it is highly possible that the water leaching solution contains these anions as in the case of the leaching solution of BM-MLi containing F⁻, Cl⁻, and SO₄²⁻ (Table 11), and PS-HLi also contains Cl⁻, SO₄²⁻, and NO₃₋ (see Table 11). In addition, HCO₃₋ and OH⁻ may also be present since CO₃²⁻ is in equilibrium with these anions.

TABLE 11
Anions present in the first wash of heated treated BM-MLi and PS-HLi.

| | | | | | | Inorg C | | |
|---|---|---|---|---|---|---|---|---|
| | | | | | | (mg/L) | | [OH⁻] |
| | Li⁺ | F⁻ | Cl⁻ | SO₄²⁻ | NO₃₋ | (CO₃²⁻ + | | (based |
| Sample | (mg/L) | (mg/L) | (mg/L) | (mg/L) | (mg/L) | HCO₃₋) | pH | on pH) |
| BM-MLi | 1,459 | 545.68 | 25.06 | 90.17 | — | 3,615 | 12.37 | 0.023M |
| PS-HLi | 2,502 | — | 532.61 | 3.84 | 3.94 | 5,323 | 12.26 | 0.018M |

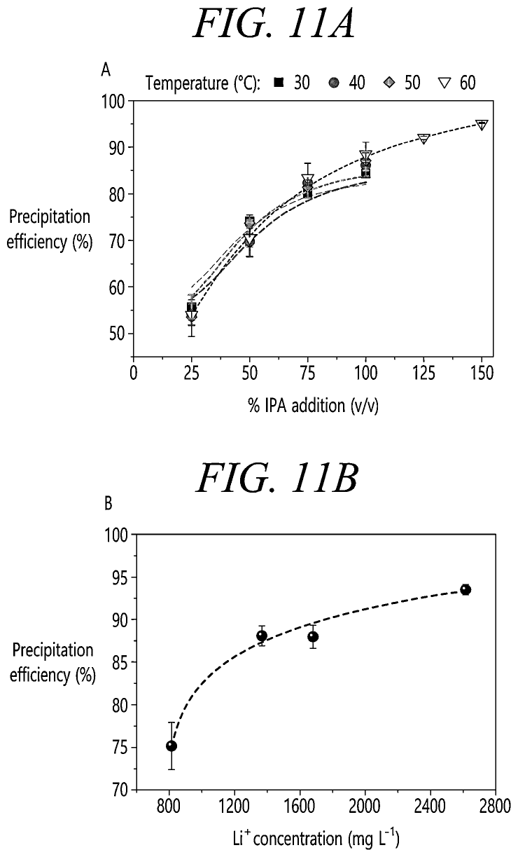

The results of precipitating Li⁺ as Li₂CO₃ using isopropyl alcohol as a co-solvent are shown in FIG. 11. After adding Na₂CO₃, the solution was stirred for 30 minutes, thereby stabilizing the system. Then, IPA was added to start Li₂CO₃ precipitation. The solution was stirred vigorously for 30 minutes, and then slowly stirred for an additional 30 minutes to allow the Li₂CO₃ particles to nucleate and aggregate. When the precipitation temperature was heated to 60° C., the Li₂CO₃ precipitation efficiency could be further increased (see FIG. 11A).

Among the important factors for precipitation, it is essential to make the Li⁺ concentration in the water leaching solution as high as possible to maximize the precipitation efficiency of Li₂CO₃ (see FIG. 11B). A precipitation efficiency of 75% can be achieved at 800 mg L⁻¹ Li⁺ but can be further increased to 93% or more when the Li⁺ concentration was 2,500 mg L⁻¹ or higher. After the Li₂CO₃ precipitate was collected, the concentration of Li⁺ dissolved in the solution ranged from 65 to 81 mg L⁻¹.

To maximize the recovery of Li₂CO₃ precipitate, centrifugation or membrane filtration with membrane pore size less than 0.22 μm can be used. It is possible to minimize the re-dissolution of Li₂CO₃ in water while removing the Na⁺ impurity from Na₂CO₃ by dehydrating the precipitate using a press and washing the same using IPA/water solution. The precipitate may be washed 2 to 6 times depending on the presence of Na⁺, but when washed less than 5 times, Na⁺ may be removed, and 90 to 99.5% Li₂CO₃ product can be achieved. Finally, high-purity Li₂CO₃ powder can be obtained after vacuum-drying at 80° C. as confirmed by the XRD patterns (see FIG. 12).

While the present disclosure has been described with reference to specific embodiments, it is not limited to those embodiments. It is evident that various modifications can be made by those skilled in the art within the scope and spirit of the present disclosure. Furthermore, even if the operational effects of certain configurations have not been explicitly stated in the description of the embodiments, it should be understood that any effects reasonably predictable from those configurations are also within the scope of this disclosure.

What is claimed is:

1. A reducing agent for the treatment of lithium ion battery (LIB) waste cathode materials and subsequent recovery of Li⁺ as Li₂CO₃, comprising an ammonium-based compound that generates NH₃ and CO₂ during heat treatment.

2. The reducing agent of claim 1, wherein the ammonium-based compound includes at least one compound selected from the group consisting of ammonium carbonate, ammonium carbamate, ammonium formate, carbamide, ammonium acetate, ammonium oxalate, ammonium citrate dibasic, ammonium citrate tribasic, and combinations thereof.

3. The reducing agent of claim 1, wherein the ammonium-based compound additionally generates at least one selected form the group consisting of H₂, CO, char, and combinations thereof during heat treatment.

4. The reducing agent of claim 1, wherein it is applied to a process for recovering lithium ions from LIB waste containing a cathode material.

5. The reducing agent of claim 4, wherein CO₂ gas is generated as a by-product during heat treatment.

6. The reducing agent of claim 4, wherein the lithium ion is recovered as Li₂CO₃.

7. The reducing agent of claim 4, wherein the cathode material includes at least one material selected from the group consisting of lithium-nickel-cobalt-manganese-based composite oxide (NCM), lithium-nickel-cobalt-aluminum-based composite oxide (NCA), lithium-cobalt-based composite oxide (LCO), lithium-manganese-based oxide (LMO), and combinations thereof.

8. A method of producing Li₂CO₃ from the LIB waste cathode materials as black mass or process scraps, the method comprising:
(a) producing a mixture by combining LIB waste containing a cathode material with the reducing agent of claim 1;
(b) thermally treating the mixture to produce heat-treated LIB waste, including Li₂CO₃ and reduced transition metals; and
(c) obtaining Li₂CO₃ by water-leaching the heat-treated LIB waste.

9. The method of claim 8, wherein the cathode material includes at least one material selected from the group consisting of lithium-nickel-cobalt-manganese-based composite oxide (NCM), lithium-nickel-cobalt-aluminum-based composite oxide (NCA), lithium-cobalt-based composite oxide (LCO), lithium-manganese-based oxide (LMO), and combinations thereof.

10. The method of claim 8, wherein the reducing agent includes at least one compound selected from the group consisting of ammonium carbonate, ammonium carbamate, ammonium formate, carbamide, ammonium acetate, ammonium oxalate, ammonium citrate dibasic, ammonium citrate tribasic, and combinations thereof.

11. The method of claim 8, wherein the reducing agent is thermally treated to generate at least one selected from the group consisting of NH₃, CO₂, H₂, CO, char, and combinations thereof.

12. The method of claim 8, wherein the mixture is prepared by mixing the LIB waste cathode material with the reducing agent in a weight ratio ranging from 1:1 to 1:4.

13. The method of claim 8, wherein the particle diameter of the LIB waste containing the cathode material is less than 100 μm.

14. The method of claim 8, wherein the heat treatment is performed in the presence of an inert gas, Ar or N₂.

15. The method of claim 8, wherein the heat treatment is conducted at a temperature ranging from 300 to 700° C. for 5 to 60 minutes, with a heating rate of 10 to 30° C. per minute.

16. The method of claim 8, wherein the step of obtaining Li₂CO₃ comprises:
(c-1) water-leaching the heat-treated LIB waste cathode material using water;
(c-2) adding sodium carbonate to the leaching solution obtained in step (c-1);
(c-3) precipitating Li₂CO₃ by adding a co-solvent to the leaching solution obtained in step (c-2);
(c-4) separating and recovering the precipitated Li₂CO₃ from step (c-3); and
(c-5) drying the recovered Li₂CO₃ from step (c-4).

17. The method of claim 16, wherein the co-solvent is isopropyl alcohol, added to the leaching solution containing sodium carbonate at a concentration ranging from 25 to 170 (v/v) %.

18. The method of claim 16, wherein the recovered Li₂CO₃ is dried at a temperature ranging from 60 to 100°° C. for 6 to 24 hours.
